(19) United States
(12) Patent Application Publication
(10) Pub. No.: US 2026/0289077 A1
(43) Pub. Date: Sep. 24, 2026

(54) SYSTEM

(71) Applicant: SoftBank Group Corp., Tokyo (JP)

(72) Inventor: Takashi TOYAMA, Tokyo (JP)

(73) Assignee: SoftBank Group Corp., Tokyo (JP)

(21) Appl. No.: 19/561,783

(22) Filed: Mar. 10, 2026

(30) Foreign Application Priority Data
Mar. 19, 2025 (JP) 2025-044988

(51) Int. Cl. G06F 40/166; G06F 40/284; G06F 40/295; G06F 40/40; G06N 3/0475; G06V 10/94; G06V 30/19; G06V 40/16; G10L 25/63; H04L 67/75

(52) U.S. Cl. CPC G06F 40/166; G06F 40/284; G06F 40/295; G06F 40/40; G06N 3/0475; G06V 30/19; G06V 10/95; G06V 40/174; G10L 25/63; H04L 67/75

(57) ABSTRACT

A system includes a processor that is configured to receive past information as input data and use a generative AI model to analyze the input data and generate consultation content, generate a prompt for determining whether use of an information technology is permitted based on the generated consultation content and input the prompt into the generative AI model, and when it is determined that use of the information technology is permitted, use a character recognition technology to extract setting information from a document, generate a prompt for guiding a user based on the extracted setting information, and input the prompt into the generative AI model.

### CROSS-REFERENCE TO RELATED APPLICATION

This application is based on and claims priority under 35 USC 119 from Japanese Patent Application No. 2025-044988 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional information support and configuration guidance systems require a human operator or a pre-defined rule set to interpret past consultation history, determine whether a particular information technology can be used in response to a new consultation, and manually search technical documents to extract configuration information. As a result, the process of generating appropriate consultation content, judging the permissibility of using specific information technologies, and guiding a user through necessary setup operations is time-consuming, inflexible, and prone to inconsistency. Moreover, although generative AI models have become capable of producing natural language responses, there is no sufficient mechanism that systematically orchestrates such models together with character recognition technologies and pattern recognition algorithms to: (i) transform unstructured historical information into useful consultation content, (ii) reliably assess whether the use of certain information technologies is permissible in a given context, and (iii) automatically extract and present concrete setup steps to a user. Therefore, there is a need for a system that can, in an integrated and automated manner, utilize a generative AI model and character recognition technology to generate consultation content from past information, determine whether a particular information technology is allowed to be used, and, when it is allowed, extract and present configuration information to guide the user step by step.

### SUMMARY

In order to solve the above-described problems, according to one aspect, there is provided a system comprising a processor, wherein the processor is configured to receive past information as input data, and to use a generative AI model to analyze the input data and generate consultation content. The processor is further configured to generate, based on the generated consultation content, a prompt for determining whether use of an information technology is permitted, and to input the prompt into the generative AI model so that the generative AI model produces an evaluation or decision regarding the permissibility of the information technology. When it is determined that use of the information technology is permitted, the processor is configured to use a character recognition technology to extract setting information from a document, generate a prompt for guiding a user based on the extracted setting information, and input the prompt into the generative AI model so that the generative AI model produces guidance text. In some embodiments, the processor is configured to generate a prompt for instructing application of a pattern recognition algorithm based on the past information and to input the prompt into the generative AI model, thereby enabling the generative AI model to leverage pattern recognition in interpreting historical data. In other embodiments, the processor is configured to generate a prompt for providing step-by-step instructions to the user based on the extracted setting information and to input the prompt into the generative AI model, thereby allowing the user to receive sequential guidance for system configuration in natural language. Through this configuration, the system can automatically generate consultation content from past information, assess whether use of an information technology is permitted, and, when permitted, extract and provide concrete configuration instructions to the user.

The term “system” refers to an integrated combination of hardware and software components, including at least one processor and associated memory or storage, configured to perform the functions described in the claims.

The term “processor” refers to any hardware circuitry or processing unit, such as a central processing unit (CPU), microprocessor, digital signal processor (DSP), graphics processing unit (GPU), or specialized accelerator, alone or in combination, capable of executing instructions to perform the claimed operations.

The term “past information” refers to information that has been previously collected or stored, including but not limited to historical consultation records, prior user inquiries, past responses, logs, and related metadata, which is used as input data for generating consultation content or for pattern analysis.

The term “input data” refers to data supplied to the system or the processor, including past information and any contextual parameters, that is processed by the processor and the generative AI model to generate outputs such as consultation content or prompts.

The term “generative AI model” refers to an artificial intelligence model, such as a large language model or other generative model, configured to generate new content (including text, prompts, or instructions) based on input data and learned parameters.

The term “consultation content” refers to information, typically expressed in natural language, that represents a consultation query, explanation, advice, or support scenario generated from past information by the generative AI model.

The term “information technology” refers to any hardware, software, network service, application, or information system whose usage or activation is to be determined or guided by the system, including but not limited to AI functions, online services, or system features.

The term “use of an information technology is permitted” refers to a state or determination where, according to a policy, rule set, or evaluation result, it is allowed for the information technology to be used, activated, or applied in response to a given consultation content.

The term “prompt” refers to a text or data sequence provided as input to the generative AI model, designed to instruct the generative AI model to perform a particular operation, such as evaluation, reasoning, content generation, or guidance creation.

The term “character recognition technology” refers to a technology, including optical character recognition (OCR) and similar methods, that converts characters contained in an image or scanned document into machine-readable text.

The term “document” refers to any medium that contains written or printed information, including but not limited to manuals, guides, specifications, or online documentation, which may be provided as an image, scanned file, or digital file for processing.

The term “setting information” refers to information describing configuration parameters, options, steps, and procedures required to set up, enable, or modify the behavior of an information technology or system function.

The term “guiding a user” refers to providing instructions, recommendations, or explanations to a user in a manner that assists the user in performing configuration operations or other tasks related to an information technology.

The term “pattern recognition algorithm” refers to any algorithm or method configured to identify patterns, correlations, or structures in past information, including statistical, machine-learning, or rule-based techniques, which can be used to improve the generation or interpretation of consultation content.

The term “step-by-step instructions” refers to a sequence of ordered, discrete guidance steps presented in a logical progression, enabling a user to perform a configuration or operation by following each step in turn.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

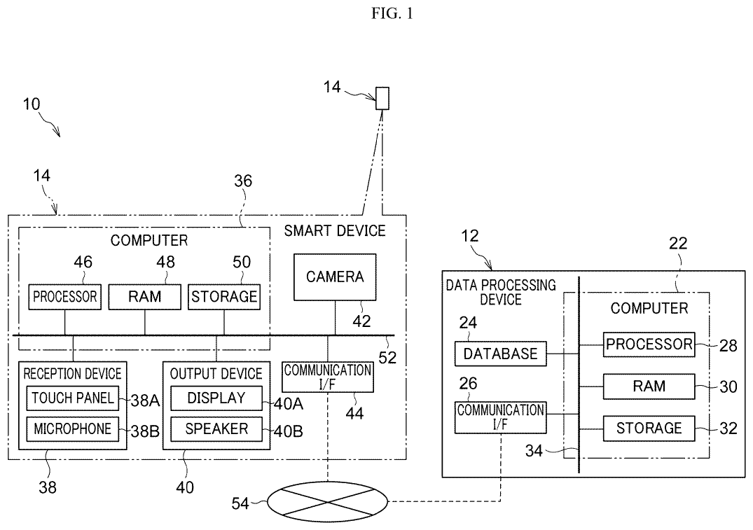

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

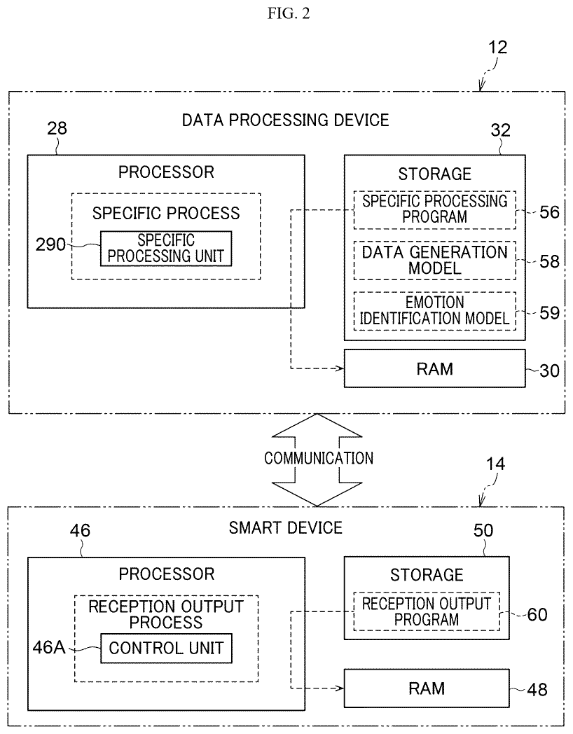

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional information processing systems that support adoption and configuration of information technology typically rely on static rule sets and manually prepared templates to generate consultation content, evaluate feasibility of information technology usage, and guide users through complex setup procedures. Such systems suffer from several technical limitations.

First, conventional systems cannot effectively leverage large volumes of heterogeneous past consultation data to automatically generate new, context-appropriate consultation cases. In many implementations, past consultation logs are merely stored and retrieved, without being structurally analyzed or used to synthesize new scenarios. As a result, the processor cannot dynamically adapt consultation content to evolving technical environments, which leads to outdated or incomplete guidance and requires extensive human intervention.

Second, conventional systems lack an integrated mechanism in which a computing device programmatically cooperates with a generative AI model to perform language-level analysis, pattern recognition, and decision support for determining the usability of an information technology configuration. Existing decision engines generally use fixed keyword lists and simple scoring logic implemented entirely on the local processor. These approaches are not well suited to processing complex, natural-language consultation content, and they do not scale well when the variety and complexity of past information grow. As a consequence, the processor tends to misjudge feasibility conditions, and the system exhibits poor robustness when confronted with ambiguous or previously unseen consultation contexts.

Third, conventional systems have difficulty transforming unstructured configuration documents, such as scanned manuals or image-based guides, into a reliable, stepwise configuration procedure that can be executed efficiently by a user. Although text recognition components may be available, these components are often loosely coupled to the rest of the system. There is typically no automated pipeline that: (i) triggers character recognition in response to a positive usability determination; (ii) extracts specific configuration items, such as connection destination information and authentication information, from recognized text; (iii) converts these items into machine-interpretable setting sequence information, including priority, dependency, and input format; and (iv) generates interactive, natural-language guidance that dynamically reflects the extracted structure. As a result, users must manually interpret technical documentation, repeatedly switch between documents and configuration screens, and correct errors through trial and error, which degrades system usability and increases configuration time.

Furthermore, known systems do not sufficiently exploit the generative capabilities of large-scale natural language models as programmable components in a computer architecture. In particular, such systems do not treat prompt sentences as structured control inputs that can specify processing conditions, evaluation criteria, and output formats at run time. Without such a mechanism, the computing device cannot offload certain language-intensive subtasks—such as scenario generation, risk extraction, or interactive guidance formulation—to a generative AI model in a controlled and reproducible manner. This results in rigid system behavior, limited adaptability to new technical domains, and inefficient use of processing resources.

Accordingly, there is a need for an improved computer-implemented system in which a processor cooperates with a generative AI model and a character recognition mechanism to: (i) generate consultation content from past information; (ii) determine usability of information technology based on natural-language analysis assisted by prompt-controlled generative processing; and (iii) automatically derive and present a stepwise, interactive configuration procedure from unstructured configuration documents. By addressing these technical problems, the system can improve the functioning of the computer itself, for example by enabling more accurate decision making, reducing manual configuration operations, and providing a more efficient pipeline from data ingestion to user guidance.

The specific processing by the specific processing unit 290 of the data processing device 12 in Example 1 is realized by the following means.

The present invention provides a server comprising a processor configured to acquire past information from a storage unit, to provide the past information as input data to a generative artificial intelligence model together with a prompt sentence that instructs the generative artificial intelligence model to summarize the past information and to generate consultation content, and to receive the consultation content generated by the generative artificial intelligence model; to perform language analysis processing and rule-based determination processing on the generated consultation content based on predetermined evaluation criteria, to generate a further prompt sentence that specifies evaluation items used in the predetermined evaluation criteria, to provide the further prompt sentence to the generative artificial intelligence model so as to cause the generative artificial intelligence model to assist in determining usability of an information technology configuration, and to generate a determination result indicating whether the information technology configuration is usable; and, in response to the determination result indicating that the information technology configuration is usable, to control a character recognition mechanism executed by a computing device or a terminal device to perform character recognition processing on document image data so as to extract character string data including setting information, to execute data extraction processing on the character string data so as to obtain configuration items including at least connection destination information and authentication information, to generate a prompt sentence including instruction content that stepwise structures a start-of-use procedure on the basis of the configuration items, to provide the prompt sentence to the generative artificial intelligence model so as to cause the generative artificial intelligence model to generate a guidance text describing the start-of-use procedure in natural language, and to cause the guidance text to be presented to a user. This enables the server to implement a technical pipeline in which the processor programmatically cooperates with the generative artificial intelligence model and the character recognition mechanism to transform past consultation data and unstructured configuration documents into structured consultation content, automated usability determinations, and interactive, stepwise configuration guidance, thereby improving computer-implemented decision accuracy, reducing manual configuration workload, and enhancing overall efficiency and reliability of information technology deployment.

The term “past information” refers to data previously stored in a storage unit, including but not limited to historical consultation logs, configuration records, usage records, and associated metadata that describe prior interactions, system states, or technical conditions.

The term “information storage unit” refers to a hardware or software component, such as a memory device, a database system, or a file system, that stores past information and provides the stored information to a processor in response to a read request.

The term “generative artificial intelligence model” refers to a machine-implemented model that performs probabilistic or neural network-based processing to generate text or other structured output in response to input data including a prompt sentence, and that is capable of performing natural-language generation, transformation, or summarization.

The term “prompt sentence” refers to a text string or equivalent structured input that specifies instructions, processing conditions, evaluation items, or desired output formats for the generative artificial intelligence model, and that controls behavior of the generative artificial intelligence model when generating output data.

The term “consultation content” refers to natural-language text or equivalent structured data that describes a consultation case, including at least user requirements, technical conditions, constraints, risks, or proposed information technology configurations.

The term “language analysis processing” refers to a series of computational operations that analyze natural-language text, including at least tokenization, syntactic or semantic analysis, keyword extraction, or entity detection, in order to derive features used for subsequent decision making. The term “rule-based determination processing” refers to processing in which a processor applies predetermined rules, such as condition-action rules or threshold-based criteria, to analysis results derived from consultation content to compute a determination result.

The term “predetermined evaluation criteria” refers to one or more rules, thresholds, or logical conditions defined in advance, which specify how consultation content is to be evaluated for usability of an information technology configuration.

The term “evaluation items” refers to individual parameters or factors used in the predetermined evaluation criteria, including but not limited to presence of specific technical terms, complexity indicators, risk indicators, or resource requirements.

The term “information technology configuration” refers to a set of technical components and their relationships, including hardware, software, networks, services, and associated parameters, used to implement a particular information processing function or system.

The term “usability of an information technology configuration” refers to a feasibility state indicating whether an information technology configuration satisfies required conditions, constraints, or policies such that the configuration can be adopted or operated in a target environment.

The term “determination result” refers to data indicating an outcome of rule-based determination processing, including at least a binary or multi-valued indicator representing whether an information technology configuration is judged to be usable, optionally with associated reason codes or scores. The term “character recognition mechanism” refers to a hardware or software component, such as an optical character recognition engine, that receives document image data and outputs corresponding character string data representing recognized text.

The term “document image data” refers to digital data representing an image of a document, such as a scanned page, a captured photograph, or an image file containing text and graphics.

The term “character recognition processing” refers to processing in which the character recognition mechanism analyzes document image data and converts visual representations of characters into digital character string data.

The term “setting information” refers to text or data contained in a document or configuration source that specifies parameters required for configuring an information technology configuration, such as addresses, identifiers, keys, or protocol settings.

The term “character string data” refers to a sequence of characters obtained by character recognition processing, including alphanumeric symbols and other textual elements representing content of a document.

The term “data extraction processing” refers to processing that analyzes character string data or setting information and identifies, isolates, and structures specific data elements, such as configuration items, according to predetermined patterns or rules.

The term “configuration items” refers to individual elements of setting information that are used to configure an information technology configuration, such as addresses, ports, identifiers, authentication credentials, or other system parameters.

The term “connection destination information” refers to configuration items that specify a target endpoint for network or service access, including at least network addresses, resource identifiers, or endpoint URLs used by a client or service to connect to a remote system.

The term “authentication information” refers to configuration items used to verify identity of a user, device, or service, including at least credentials, secret keys, tokens, certificates, or similar data used in an authentication procedure.

The term “start-of-use procedure” refers to a sequence of operations and configuration steps that must be performed to place an information technology configuration into a usable state for a user or system.

The term “guidance text” refers to natural-language text generated to instruct a user in performing the start-of-use procedure or related configuration actions, including explanations, stepwise instructions, confirmations, and corrective guidance.

The term “pattern recognition algorithm” refers to a computational procedure that identifies patterns or regularities in data, such as classifications, clusters, or feature correlations, based on statistical, machine-learning, or rule-based techniques.

The term “processing conditions” refers to parameters that specify how a pattern recognition algorithm or other processing is to be executed, including at least target attributes, thresholds, scopes, or filtering conditions.

The term “output format” refers to a structural specification indicating the representation of output data, such as lists, tables, labels, scores, or annotated text, produced by a pattern recognition algorithm or by the generative artificial intelligence model.

The term “classification of consultation content” refers to processing in which consultation content is assigned to one or more categories, such as technical fields, problem types, or risk levels, based on recognized features.

The term “extraction of technical fields” refers to processing in which technical domains or subject areas, such as network technologies, storage technologies, or security technologies, are identified and labeled in consultation content or past information.

The term “extraction of risk factors” refers to processing in which portions of consultation content that describe potential failures, vulnerabilities, performance issues, or compliance issues are identified and structured as explicit risk indicators.

The term “evaluation of complexity” refers to processing in which a complexity level of consultation content or of an information technology configuration is determined based on criteria such as number of components, interdependencies, technical depth, or required expertise.

The term “setting sequence information” refers to structured data representing an ordered arrangement of setting items and associated metadata, including priority, dependency relationships, and input formats, that defines a recommended sequence for configuration.

The term “priority of a setting item” refers to a relative importance or execution order assigned to the setting item within a set of configuration steps, indicating the degree to which the setting item should be processed earlier or later in a configuration procedure.

The term “dependency of a setting item” refers to a relationship indicating that configuration or correctness of the setting item depends on configuration or correctness of one or more other setting items.

The term “input format of a setting item” refers to a structural and syntactic specification of values permitted for the setting item, such as data type, length, pattern, or allowed value range.

The term “metadata” refers to auxiliary data associated with configuration items or setting sequence information, including descriptors such as priority values, dependency relationships, validity flags, timestamps, or other annotations used for processing or presentation.

The term “interactive procedure” refers to a sequence of interactions between a system and a user, in which the system presents instructions or questions and receives responses or confirmations from the user, and in which subsequent steps may change based on the user's input or system state.

The term “stepwise operation instructions” refers to instructions that guide a user through a configuration or usage process in discrete steps, each step describing a specific action, input, or verification to be performed before proceeding to a subsequent step.

The term “confirmation requests” refers to prompts presented to a user to verify correctness, completion, or acceptance of particular configuration items or steps before the procedure advances. The term “corrective guidance” refers to instructions presented to a user when an error, inconsistency, or invalid input is detected, the instructions indicating actions to correct the error or to adjust configuration parameters.

The term “computing device” refers to any electronic device that executes instructions, including but not limited to servers, personal computers, and embedded systems, capable of running software modules that implement parts of the described processing.

The term “terminal device” refers to a user-facing computing device, such as a client device, portable device, or display device, that communicates with a server and presents guidance text or configuration interfaces to a user.

The term “processor” refers to one or more processing units, such as a central processing unit or a microcontroller, that execute instructions of a program to perform the functions described for the server, computing device, or terminal device.

In one embodiment, a server, a terminal, and a user cooperate to implement the claimed system. The server comprises at least one processor, a main memory, a non-volatile storage device, and a network interface. The server executes an operating system such as a general-purpose server operating system and an application program implementing the functions described below. The terminal comprises at least one processor, a memory, a display device, an input device such as a touch screen, and optionally an image acquisition device such as a camera or a scanner interface.

The terminal executes a client application that communicates with the server and performs character recognition and guidance presentation.

The server stores past information in a storage system implemented as a relational database management system or a key-value store. The server stores each past consultation record as a structured data object including fields for consultation text, technical domain labels, timestamps, risk annotations, and configuration outcomes. The server represents each record internally as a serialized object or as a row in a table with typed columns. The server further maintains indices on frequently used fields, such as domain labels and timestamps, so that the processor can retrieve subsets of past information efficiently.

The server uses a generative AI model to generate consultation content and to assist in analysis. In one embodiment, the generative AI model is a transformer-based neural network trained for natural language generation. The server stores model parameters in a parameter store and executes the model either locally on a computing node equipped with a graphics processing unit or by calling an external AI service over a network. The model architecture includes multiple self-attention layers, feed-forward layers, layer normalization, and positional encodings. The server represents input text as token sequences, and the server applies an embedding layer to map tokens to high-dimensional feature vectors. The server configures the generative AI model with hyperparameters such as number of layers, hidden size, attention heads, and temperature and top-k values controlling sampling behavior.

The server uses a prompt sentence as a structured control input to the generative AI model. The server constructs the prompt sentence by concatenating fixed instruction text with selected past consultation summaries and explicit formatting markers. For example, the server uses a prompt sentence such as:

“Based on the past ISC consultation data stored in our database, generate three new consultation cases related to cloud service adoption. For each case, describe the user's business requirements, the proposed IT architecture, and potential security and performance risks.”

The server embeds such a prompt sentence into an input object that also includes model control parameters. The server converts the prompt sentence into token IDs using a tokenizer consistent with the generative AI model's vocabulary, and the server feeds these token IDs into the neural network. The server receives output token probabilities from the neural network and decodes them into natural-language text, which the server stores as consultation content.

The server performs language analysis processing on the consultation content using a combination of classical natural language processing algorithms and neural-network-based feature extraction. The server represents the consultation content as a sequence of tokens, and the server computes part-of-speech tags, dependency trees, and named entities using an NLP library. The server stores these intermediate features in an in-memory data structure that includes token indices, lemma forms, syntactic relations, and entity types. Additionally, the server feeds the consultation content into an encoder network derived from the generative AI model to obtain contextual embeddings, and the server uses these embeddings as feature vectors for downstream classification tasks.

The server performs rule-based determination processing based on predetermined evaluation criteria. The server maintains a rule set that specifies required technical terms, risk patterns, and complexity thresholds. Each rule is defined as a condition on extracted features, such as “presence of at least one encryption-related term and one network isolation term” or “maximum number of distinct remote services below a specified limit.” The server applies these rules to the feature representation of the consultation content, computing a score and a binary usability flag. The server optionally generates an additional prompt sentence to request structured justification from the generative AI model. For example, the server uses a prompt sentence such as:

“Given the following consultation case, list the key technical components, evaluate whether the proposed configuration is feasible for a medium-sized organization, and summarize the main reasons for your judgment.”

The server includes the consultation content in the same input and instructs the generative AI model to output a structured explanation. The server then parses the explanation, extracts reason codes, and combines them with the rule-based results to produce a determination result with both a flag and a rationale.

The server controls a character recognition mechanism when the determination result indicates that an information technology configuration is usable. In one embodiment, the terminal executes an optical character recognition engine such as a general OCR engine integrated via a native library. The terminal receives document image data from a scanner, a camera, or a file selection interface. The terminal converts the image data into a normalized format, such as grayscale image with reduced noise and corrected orientation. The terminal then invokes the OCR engine with specified parameters, including language models, page segmentation mode, and character whitelists to improve recognition accuracy for technical strings such as URLs and keys.

The terminal obtains character string data from the OCR engine and transmits the recognized text to the server, or alternatively, the terminal performs data extraction locally. The terminal or the server applies data extraction processing using a combination of regular expressions, finite-state patterns, and simple classifiers to identify configuration items such as connection destination information and authentication information. For example, the terminal identifies lines matching patterns like “Server URL: http(s):// . . . ” or “API key: [alphanumeric string]” and stores each recognized pair as a key-value entry in a configuration item structure.

The server generates a start-of-use procedure from the configuration items. The server first derives setting sequence information by assigning priorities and dependencies. The server models setting items as nodes in a directed acyclic graph, where edges represent dependency relations, such as “authentication information depends on account creation” or “endpoint configuration depends on network connectivity.” The server performs a topological sort on this graph to obtain an execution order, and the server assigns priority values based on this order. The server also attaches metadata describing input formats, including expected data types, allowed ranges, and validation patterns for each setting item.

The server then constructs a prompt sentence that encodes the setting sequence information and desired style of user guidance. For example, the server uses a prompt sentence such as: “Generate a step-by-step setup guide for the following configuration items: (1) Server URL: https://example.com/api, (2) Port: 443, (3) API key: [redacted token]. Present each step in the order implied by dependencies, explain what the user must enter or verify on each screen, and include confirmation messages after critical steps.”

The server encodes the setting sequence information into this prompt sentence using explicit labels and sequence markers. The server submits the prompt sentence to the generative AI model, and the generative AI model outputs guidance text. The server parses the output into separate steps and sends these steps to the terminal as a structured guide to be displayed to the user.

The terminal presents the guidance text to the user via a graphical user interface. The terminal maps each step in the guidance text to a corresponding configuration screen or input field. The terminal optionally pre-fills fields with extracted configuration values and highlights fields where user input is required. The terminal displays confirmation requests and corrective guidance based on the guidance text, and the terminal records completion states for each step in a local data structure. The terminal periodically sends status updates to the server, which the server stores in the database to maintain a record of configuration progress.

This system improves computer technology by optimizing internal data flows, reducing computational redundancy, and enhancing decision accuracy using specific algorithms and data structures. The server uses indices and filtered queries to limit the volume of past information processed at any time, which reduces memory loads and accelerates I/O operations. The server computes feature vectors for consultation content once and caches them for reuse across multiple decision rules, which decreases overall computation time. The integration of rule-based logic with neural embeddings improves the precision of usability determinations compared with purely keyword-based methods, because the embeddings capture contextual relationships between terms, thereby reducing false positives and false negatives in technical judgments.

The system also reduces communication load and latency between the server and the generative AI model. The server encodes complex instructions and evaluation criteria compactly in prompt sentences, avoiding multiple round-trip communications that would otherwise be required for separate subtasks. By selecting only essential portions of past information and setting sequence information as input to the generative AI model, the server limits token counts and thus reduces both processing time and bandwidth consumption.

The generative AI model in this system operates under controlled prompts and explicit feature constraints rather than serving as a generic text generator. The server uses error functions and training procedures tailored to this use case. For example, the generative AI model is fine-tuned with a supervised learning dataset composed of past consultation content paired with expert evaluations and setup guides. The server configures the model training with a cross-entropy loss over token sequences and applies gradient-based weight updates using an optimization algorithm such as an adaptive gradient method. The training data include augmented examples generated by paraphrasing, synonym substitution, and structural variation, thereby improving robustness to diverse input forms. As a result, the trained model produces more consistent and structurally aligned outputs when controlled through prompt sentences, which leads to predictable and verifiable behavior in a production environment.

The server employs non-conventional processing sequences to achieve technical advantages. Instead of directly presenting raw OCR text to a user, the server transforms the text into structured configuration items, derives a dependency graph, and then uses the generative AI model to articulate a stepwise guide that conforms to this graph. This multi-stage pipeline enables the system to detect and correct inconsistencies, such as missing or conflicting settings, before presenting instructions to the user. Consequently, configuration errors and subsequent corrective interactions are reduced, which improves both setup speed and reliability.

The terminal benefits from reduced cognitive load for the user and from automatic mapping between guidance text and user interface elements. The terminal stores a mapping table between semantic identifiers in the guidance text and concrete screen elements, such as specific text fields or buttons. By following this mapping, the terminal can highlight or focus appropriate input fields as the user progresses through the steps, which optimizes user interaction flows and reduces input errors.

In alternative embodiments, the server executes the character recognition mechanism locally instead of delegating it to the terminal. The server then receives raw document images from the terminal, performs pre-processing such as de-skewing and binarization, and runs the OCR engine in a server-side environment. This variant is advantageous for environments where terminals have limited processing capabilities or energy constraints. The system architecture permits dynamic selection between server-side and terminal-side OCR based on device profiles and network conditions.

In another embodiment, the server uses a separate classifier network, such as a lightweight convolutional or recurrent neural network, to perform preliminary classification of consultation content into coarse categories before invoking the generative AI model for detailed generation or analysis. This classifier operates on feature vectors derived from past information and reduces the number of times the generative AI model must be called, thereby conserving computational resources while maintaining high overall decision quality.

In yet another embodiment, the server logs prompt sentences and corresponding generative outputs together with rule-based determination results in a dedicated audit store. The server periodically analyzes this log using pattern recognition algorithms to identify recurring error patterns or suboptimal decisions. Based on this analysis, the server adjusts rule thresholds, modifies prompt templates, or updates training data for the generative AI model. This feedback loop enables continuous improvement of system performance and further reduces misjudgments over time.

By structuring data, controlling AI processing through prompt sentences, and integrating OCR and dependency-aware sequencing into a single pipeline, the system achieves technical effects in terms of improved processing speed, higher accuracy of IT usability judgments, reduced communication overhead, and lower error rates in configuration procedures. The server, the terminal, and the user thereby interact through a coordinated architecture that goes beyond simple automation of human tasks and instead enhances the way computing devices analyze, structure, and act upon complex technical documentation and consultation data.

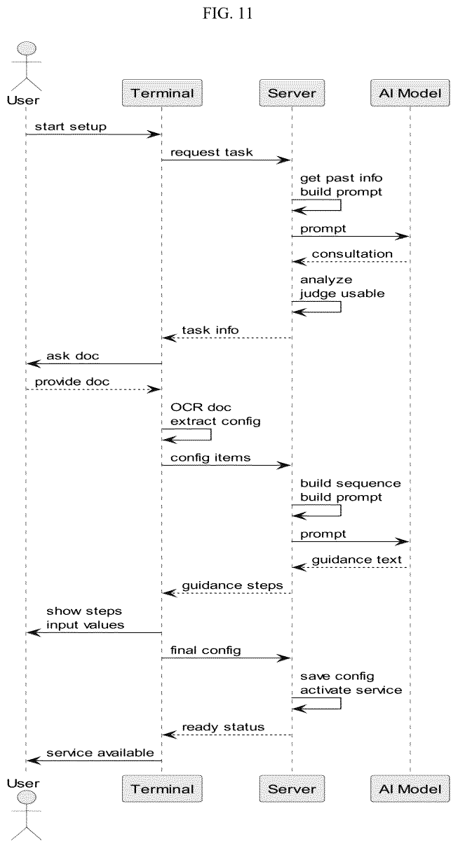

The following describes the processing flow using FIG. 11.

### Step 1:

The server acquires past information from a storage system.

The server uses a database client to send a query to a database and receives a set of past consultation records as input. The input includes consultation texts, timestamps, domain labels, and previous configuration outcomes. The server parses each record into an internal object structure and stores the objects in main memory. Based on this input, the server filters the records according to predefined conditions, such as technical domain or date range, and outputs a curated subset of past information as a list of consultation objects ready for prompt construction.

### Step 2:

The server constructs a prompt sentence for a generative AI model.

The server receives the curated list of consultation objects as input. The server extracts representative fields, such as short summaries and risk notes, and concatenates them with fixed instruction text to form a prompt sentence. For example, the server generates the text:
“Based on the past ISC consultation data stored in our database, generate three new consultation cases related to cloud service adoption. For each case, describe the user's business requirements, the proposed IT architecture, and potential security and performance risks.”

The server performs string formatting and truncation to respect length limits, tokenizes the prompt sentence using the tokenizer associated with the generative AI model, and outputs a token sequence and the final prompt sentence string as input for model invocation.

### Step 3:

The server invokes the generative AI model to generate new consultation content.

The server receives the token sequence and prompt sentence as input. The server calls the generative AI model through an API, passing the token sequence, model parameters (such as temperature and maximum output length), and a model identifier. Internally, the generative AI model executes forward passes of a transformer network, computing attention scores and probability distributions for output tokens. The server collects the generated token sequence, decodes it into text, and outputs one or more generated consultation contents as structured text objects.

### Step 4:

The server analyzes the generated consultation content using language analysis processing.

The server receives the generated consultation content as input. The server applies natural language processing tools to tokenize the text, assign part-of-speech tags, and build dependency trees. The server also detects named entities such as service types, platforms, and security mechanisms. The server computes additional numerical features, including sentence count, technical term frequency, and risk indicator presence. The server aggregates these features into a feature vector for each generated consultation and outputs a set of feature vectors and annotated texts for further rule-based processing.

### Step 5:

The server performs rule-based determination processing to evaluate usability of an information technology configuration.

The server receives feature vectors and annotated consultation texts as input. The server applies a rule set that checks conditions such as presence of required security terms, acceptable complexity level, and compliance with predefined resource constraints. For each consultation, the server evaluates the rules, sums weighted scores, and compares the total to a threshold. Based on these computations, the server generates a determination result containing a usability flag and a score. The server outputs a list of determination results associated with the corresponding consultation contents.

### Step 6:

The server optionally requests structured justification from the generative AI model.

The server receives a generated consultation content and its preliminary determination result as input when an explanation is needed. The server constructs a second prompt sentence that embeds the consultation text and asks for identification of key technical components and reasoning. For example, the server generates:
“Given the following consultation case, list the key technical components, evaluate whether the proposed configuration is feasible for a medium-sized organization, and summarize the main reasons for your judgment.”

The server appends the consultation text, tokenizes the combined prompt, and calls the generative AI model. The model outputs a structured explanation text. The server parses the text to extract reason codes and justification segments and outputs an enriched determination result that includes both the usability flag and explanatory data.

### Step 7:

The server selects consultations judged as usable and prepares OCR and configuration tasks. The server receives all determination results and associated consultation contents as input. The server filters the list to extract only those entries where the usability flag is positive. For each selected entry, the server creates a task record specifying that configuration guidance should be generated. The task record includes identifiers for required documents, relevant technical parameters, and the user or terminal. The server writes these task records to a task queue or database table and outputs a set of task identifiers to be consumed by the terminal.

### Step 8:

The terminal acquires configuration documents needed for the selected tasks.

The terminal receives a task identifier and associated metadata from the server as input. Based on this input, the terminal prompts the user to select or capture configuration documents, such as a PDF manual or an image of a printed setup guide. The terminal activates a file chooser or camera interface, obtains the selected or captured file as document image data, and stores it in local storage. The terminal outputs a reference (such as a file path or URI) to the stored document image data for subsequent OCR processing.

### Step 9:

The terminal executes character recognition on the configuration documents.

The terminal receives the document image data reference as input. The terminal loads the image file, performs pre-processing such as resizing, noise reduction, and deskewing, and invokes an OCR engine with parameters optimized for technical documents. The OCR engine analyzes pixel patterns and applies recognition models to detect characters and text lines. The terminal receives recognized character data from the OCR engine, assembles them into a continuous text string preserving line breaks where possible, and outputs the resulting character string data as the OCR result.

### Step 10:

The terminal or the server extracts configuration items from the recognized text.

The terminal or the server receives the character string data as input. The processing component applies pattern-matching algorithms, including regular expressions for URLs, ports, and keys, and rule-based segmentation for label-value pairs. The component scans the text for lines such as “Server URL: . . . ”, “Port: . . . ”, and “API key: . . . ”, extracts corresponding values, and normalizes them (for example, trimming whitespace or validating URL syntax). The component groups the extracted values into configuration item objects, each containing a key, a value, and a type. The component outputs a structured list of configuration items, including connection destination information and authentication information.

### Step 11:

The server derives setting sequence information and dependency relations from configuration items. The server receives the list of configuration items as input. The server analyzes semantic labels and types to infer dependencies, such as “network settings before authentication” or “endpoint configuration before API key registration.” The server models items as nodes in a graph and adds directed edges based on these inferred relations. The server performs a topological sort to obtain a valid order and assigns a priority index to each item. The server also attaches metadata describing input formats and validation rules. The server outputs a setting sequence structure containing an ordered list of items and associated metadata.

### Step 12:

The server constructs a prompt sentence for generating a start-of-use procedure.

The server receives the setting sequence structure as input. The server serializes the ordered configuration items and metadata into a structured text description and embeds this description into an instruction template. For example, the server generates a prompt sentence such as: “Generate a step-by-step setup guide for the following configuration items: (1) Server URL: https://example.com/api, (2) Port: 443, (3) API key: [redacted token]. Present each step in the order implied by dependencies, explain what the user must enter or verify on each screen, and include confirmation messages after critical steps.”

The server tokenizes the prompt, attaches model control parameters, and outputs a prepared model input containing the prompt sentence and token sequence.

### Step 13:

The server invokes the generative AI model to produce guidance text.

The server receives the prepared model input as input. The server calls the generative AI model and supplies the prompt tokens and control parameters. Inside the model, the transformer layers compute attention over the configuration description and instruction text, and generate tokens that describe individual setup steps in natural language. The server decodes the output tokens into text and segments the text into step-wise guidance items based on markers such as numbered lists or headings. The server outputs structured guidance text, including individual step descriptions and any confirmation or error-handling instructions.

### Step 14:

The terminal presents the guidance text and maps it to user interface elements.

The terminal receives the structured guidance text from the server as input. The terminal parses each step to identify references to specific configuration items, such as “Server URL” or “API key,” and maps these references to known screen elements in the client application. The terminal generates a sequence of screens or dialogs, each displaying the corresponding step text and highlighting the relevant input field. The terminal pre-fills fields with extracted values where appropriate and adds buttons for “Next,” “Back,” and “Confirm.” The terminal outputs an interactive configuration flow that is visible and operable by the user.

### Step 15:

The user executes configuration operations according to the guidance.

The user receives the interactive configuration flow on the terminal display as input. The user reads the instructions, taps on highlighted fields, and enters or confirms values such as server URLs, ports, and keys. The user responds to confirmation requests and follows any corrective guidance if validation errors appear. The user's actions generate input events and updated configuration values, which the terminal records in a local configuration state. The terminal outputs updated settings and step completion statuses as the user progresses through the flow.

### Step 16:

The terminal and the server finalize configuration and update system status.

The terminal receives the completion status of all steps as input. The terminal validates that mandatory fields are populated and that dependency constraints are satisfied. If validation succeeds, the terminal sends a status message containing final configuration values and a completion flag to the server. The server receives this data, stores the configuration values in a management database, and marks the associated task as completed. The server outputs an updated system state indicating that the information technology configuration is active and usable, and the terminal enables access to main service functions based on the stored configuration.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented support systems in industrial and service environments rely on static rule sets and manually authored procedures to derive consultations, to determine whether advanced information technologies such as artificial intelligence may be used, and to configure automated work apparatuses. In such systems, a processor typically applies fixed business rules to past records and then presents pre-defined templates to users. Because these systems are not designed to generate or refine machine-executable instructions or user guidance dynamically from accumulated history, they fail to exploit recent advances in generative AI models and prompt-based control of such models.

More specifically, conventional systems suffer from several technical limitations. First, historical data such as past consultation logs, work histories, and execution results are stored but are not effectively converted into structured knowledge that can be reused to generate new consultation content and new work instructions. This leads to redundant processing, increased storage of unnormalized logs, and inefficient use of processor and memory resources because the same types of analyses must be repeated manually or via ad hoc scripts.

Second, existing architectures do not provide a unified processor-side mechanism for generating, managing, and sequencing prompt sentences to control a generative AI model for multiple distinct purposes, including consultation generation, AI-usage evaluation, guidance generation, and automated apparatus instruction generation. As a consequence, separate subsystems or applications are often deployed, each making independent calls to AI services. This fragmented approach results in duplicated communication overhead, inconsistent evaluation criteria, and increased latency, thereby degrading overall system performance and reliability.

Third, typical systems handle optical character recognition of documents and configuration extraction as isolated preprocessing tasks without integrating the extracted configuration information with dynamic, AI-generated consultation content and work instructions. This prevents the processor from automatically transforming unstructured documents into structured control parameters that can be safely and efficiently applied to automated work apparatuses. The lack of such integration requires human operators to manually interpret and input parameters, which prolongs setup time, increases the risk of error, and prevents consistent enforcement of safety and operational constraints. Fourth, conventional solutions do not close the loop between machine execution and AI-assisted planning. Execution result information from automated work apparatuses and feedback information from users are often logged in heterogeneous formats or isolated databases and are not systematically normalized and reused as input data for subsequent AI-based consultation and instruction generation. This leads to poor adaptability of the system, as the generative AI model cannot effectively learn from or be conditioned by prior execution behavior and user interactions through well-defined prompt sentences.

Fifth, user guidance mechanisms in existing systems typically provide one-way, static instructions that do not adapt to user confirmations, corrections, or feedback. These systems do not employ an integrated processor-controlled generative AI model to produce interactive, stepwise guidance content synchronized with underlying configuration states and evaluation conditions. Consequently, they cannot efficiently assist users in refining configuration parameters, identifying inconsistencies, or improving work procedures, which makes the human-machine interaction less efficient and error-prone.

Therefore, there is a need for an improved computer-implemented system and server-side processing architecture that (i) unifies the generation and use of prompt sentences to control a generative AI model for multiple stages of consultation, evaluation, guidance, and apparatus control; (ii) automatically extracts and structures configuration information from documents via character recognition, and integrates this with historical and execution data; (iii) systematically applies safety and operational conditions to AI-generated work instruction information; and (iv) continuously updates reusable history information based on execution results and user feedback. Such a system should improve the efficiency, reliability, and adaptability of the underlying computer technology for managing complex, AI-assisted workflows and automated apparatus control.

The specific processing by the specific processing unit 290 of the data processing device 12 in Application Example 1 is realized by the following means.

The present invention provides a server comprising a processor configured to (i) receive past information as input data, generate prompt sentences for a generative AI model to cause the generative AI model to analyze the input data and generate consultation content, and input the prompt sentences to the generative AI model; (ii) refer to evaluation conditions based on the consultation content output from the generative AI model, determine whether use of an information processing resource is permitted, generate prompt sentences for the generative AI model for determining the permissibility of the use of the information processing resource, and input the prompt sentences to the generative AI model; (iii) when the use of the information processing resource is determined to be permitted, input documents acquired as image data to a character recognition algorithm, extract configuration information from the documents, and convert the extracted configuration information into structured data; (iv) integrate the configuration information expressed as the structured data with past work history data related to the consultation content, generate guidance content for performing stepwise guidance to a user, generate prompt sentences for the generative AI model for generating the guidance content, and input the prompt sentences to the generative AI model; (v) receive the past work history data and the consultation content as inputs, generate prompt sentences for the generative AI model for generating new work instruction information for an automated work apparatus, and input the prompt sentences to the generative AI model to acquire the work instruction information; (vi) compare the work instruction information with safety conditions and operational conditions, determine appropriateness of the work instruction information, determine control parameters to be set in the automated work apparatus based on a result of the determination, transmit the control parameters to the automated work apparatus, and cause the automated work apparatus to start work; (vii) transmit guidance information including the guidance content and the work instruction information to a user information terminal via a communication network, and cause the user information terminal to provide guidance to the user through display or audio output; and (viii) store execution result information acquired from the automated work apparatus and feedback information acquired from the user as history information, and update the history information into a format usable as input data for the generative AI model for subsequent generation of the consultation content and subsequent generation of the work instruction information. This enables an integrated, prompt-driven computation framework in which the server efficiently orchestrates generative AI processing, character recognition, rule-based evaluation, and apparatus control, thereby improving computer system performance by reducing redundant processing, enforcing safety and operational constraints programmatically, and continuously refining consultation and work instruction generation based on accumulated execution and feedback data.

The term “processor” refers to a hardware information processing unit, or a combination of such units, configured to execute instructions to perform data input, data analysis, control logic, and communication with external components in order to implement the functions described in the present disclosure.

The term “past information” refers to data previously collected or stored in a storage device, including but not limited to consultation logs, work history records, execution result records, configuration records, and user interaction logs, which are used as input data for subsequent processing.

The term “input data” refers to any data supplied to the processor or to a model executed under control of the processor, including past information, configuration information, work history data, and user feedback, which is processed to generate consultation content, guidance content, or work instruction information.

The term “generative AI model” refers to a machine-learning model configured to generate output data, such as natural language text or structured data, in response to input data and instructions, and which is controlled using prompt sentences provided by the processor.

The term “prompt sentence” refers to a sequence of symbols, typically in natural language or a structured format, generated by the processor and supplied to the generative AI model to cause the generative AI model to perform a specific task, such as consultation generation, evaluation, guidance generation, or work instruction generation.

The term “consultation content” refers to information generated by the generative AI model based on past information and prompt sentences, the information including analysis, recommendations, or proposed actions regarding operation, configuration, or use of information processing resources or automated work apparatuses.

The term “information processing resource” refers to a computational facility, service, or functionality, including but not limited to artificial intelligence services, data processing modules, or external computing systems, which may be selectively used or restricted based on evaluation conditions.

The term “evaluation conditions” refers to rules, thresholds, criteria, or policies, stored in a storage device and accessed by the processor, for determining whether use of an information processing resource is permitted and for evaluating the appropriateness of work instruction information.

The term “document” refers to information recorded in a human-readable or machine-readable form, including but not limited to instruction sheets, manuals, and specification sheets, which may be obtained as image data and subjected to character recognition processing.

The term “image data” refers to digital data representing visual information, including raster images of documents or scenes, which can be processed by a character recognition algorithm to extract textual content.

The term “character recognition algorithm” refers to a computational procedure executed by the processor, or by a related processing unit, for detecting and recognizing characters or symbols in image data to produce corresponding textual data.

The term “configuration information” refers to data obtained from documents or other sources that specifies parameters, settings, or options for operating an automated work apparatus or a computer-based system, such as identifiers, speed settings, temperatures, or modes of operation.

The term “structured data” refers to configuration information or other information arranged according to a predefined schema or format, such as key-value pairs, tables, or hierarchical data structures, enabling systematic processing by the processor.

The term “past work history data” refers to historical records related to performed work, tasks, operations, or processes, including associated parameters, outcomes, and conditions, which are stored in a storage device and used to generate or evaluate new consultation content or work instructions.

The term “guidance content” refers to information generated under control of the processor, directly or via the generative AI model, for providing stepwise or interactive instructions, explanations, or recommendations to a user regarding configuration, operation, or verification tasks.

The term “user” refers to a human operator or person who interacts with the system, including viewing or listening to guidance content, providing confirmations or corrections, and operating equipment or terminals in accordance with the guidance.

The term “automated work apparatus” refers to a machine, device, or system capable of performing physical or logical tasks with reduced human intervention, including industrial robots, manufacturing equipment, or automated processing lines, whose operation can be controlled via control parameters.

The term “work instruction information” refers to data representing instructions, procedures, or task sequences, generated by the generative AI model and processed by the processor, for controlling or configuring an automated work apparatus.

The term “safety conditions” refers to constraints, limits, or rules related to safe operation of an automated work apparatus or system, including maximum allowable speeds, temperatures, or forces, as well as prohibited operations or combinations of operations.

The term “operational conditions” refers to constraints, requirements, or performance-related parameters for operating an automated work apparatus or system, including productivity targets, quality constraints, capacity limits, or timing requirements.

The term “control parameters” refers to values or settings determined by the processor based on work instruction information and evaluation conditions, which are transmitted to an automated work apparatus to define or modify its operation.

The term “user information terminal” refers to an electronic device used by a user to interact with the system, including but not limited to a portable terminal, a desktop terminal, or a display apparatus, which is capable of receiving data from the server and providing outputs such as visual displays or audio signals.

The term “communication network” refers to a wired or wireless communication infrastructure that interconnects the server, user information terminals, automated work apparatuses, or other components, and transports data such as prompt sentences, guidance content, and control parameters. The term “guidance information” refers to data transmitted from the server to the user information terminal, including guidance content, work instruction information, and related metadata, which is used to present operational guidance to the user.

The term “execution result information” refers to data acquired from an automated work apparatus during or after execution of tasks, including status information, error codes, completion indicators, performance metrics, and other operational results.

The term “feedback information” refers to data provided by a user, via a user information terminal or other input device, indicating confirmations, corrections, comments, or assessments related to guidance content, configuration information, or system behavior.

The term “history information” refers to aggregated or stored data including past information, execution result information, and feedback information, which is maintained in a storage device and is usable as input data for subsequent processing by the processor or by the generative AI model.

In one embodiment, a server includes a processor, a memory, a storage device, a network interface, and interfaces for communication with one or more automated work apparatuses. The server executes a program implemented, for example, in a high-level programming language on a general-purpose operating system running on standard server hardware. The memory stores executable modules including a prompt generation module, a generative AI model interface module, an evaluation module, an optical character recognition (OCR) interface module, a guidance generation module, a work instruction generation module, and a history management module.

In one embodiment, the server uses a relational database system executing on the same hardware platform or on a separate storage server to store past information, past work history data, evaluation conditions, safety conditions, operational conditions, configuration information, execution result information, feedback information, and history information. The database stores such information in normalized tables with defined schemas, including columns for timestamps, machine identifiers, parameter names, parameter values, consultation identifiers, and instruction identifiers. The server accesses these tables through a database driver library, and converts query results into in-memory data structures such as associative arrays or structured records.

In one embodiment, the server interacts with a generative AI model deployed on a remote computation service or on a local accelerator device. The generative AI model is implemented as a neural network including multiple transformer blocks. Each transformer block comprises a multi-head self-attention mechanism, layer-normalization layers, and feed-forward networks with non-linear activation functions. The model parameters include weight matrices for query, key, value, and output projections in the attention layers, as well as weight matrices and bias vectors in the feed-forward layers. The model is trained, before deployment, on large corpora of technical documents, operation manuals, and historical logs using a supervised or self-supervised learning procedure. In one embodiment, during training of the generative AI model, the server or a separate training host minimizes a loss function defined as a cross-entropy between predicted token distributions and ground-truth target tokens. The training procedure updates model weights using a stochastic gradient descent method or a variant thereof, such as Adam, with adaptive learning rates. The training system applies regularization methods, such as dropout and weight decay, and may perform data augmentation by randomly masking input tokens or permuting portions of sequences to improve robustness. As a result, the trained model encodes statistical relationships between textual tokens and can generate coherent consultation content and work instructions when given appropriate prompt sentences.

In one embodiment, the server generates a prompt sentence by concatenating fixed template strings with values retrieved from the database, including past consultation entries and work history records. The server stores each prompt sentence as a sequence of characters in memory, and converts the sequence into token identifiers using a tokenizer compatible with the generative AI model. The model interface module generates an input tensor from the token identifiers and sends the tensor to the generative AI model via an application programming interface, for example using secure network communication. The model outputs a sequence of token probability distributions, from which the model interface module selects tokens according to a decoding strategy such as greedy decoding or temperature-controlled sampling, and reconstructs a textual response.

In one embodiment, the server generates consultation content based on past information. The server retrieves at least one prior consultation record and associated work history from the database, orders the records by time or relevance, and truncates or summarizes the records to fit within a predetermined token limit for the generative AI model. The server then generates a prompt sentence such as:

“Past ISC consultations:
1) Robot A assembled Product X at speed 80, but defect rate increased when temperature exceeded 70° C. Recommended maximum speed: 60 at 75° C.
2) Robot B experienced frequent jams when conveyor speed exceeded 50.

Using the above data, generate a new ISC consultation for operating Robot A and Robot B together on a mixed-product line. Include recommended speed and temperature ranges, and highlight any potential risks.”

The server transmits this prompt sentence to the generative AI model and receives consultation content. The consultation content may include proposed operating ranges, risk descriptions, and parameter suggestions expressed in natural language. The server parses the consultation content using pattern matching and structural markers (such as numbered lists or key phrases) to identify candidate parameter values and reasoning segments.

In one embodiment, the server evaluates whether use of an information processing resource is permitted. The evaluation module loads evaluation conditions from a configuration dataset that specifies, for example, allowed types of AI processing for different risk classes, prohibited terms indicative of unsafe actions, and thresholds on suggested speeds or temperatures. The server applies string-search algorithms and regular expression matching to the consultation content to detect prohibited patterns. The server also computes numerical features, such as suggested maximum speed versus stored safety limits, and compares such features against threshold values in the evaluation conditions. The server aggregates these checks into a decision flag. This evaluation is performed by explicit processor instructions and data comparisons, rather than relying on opaque internal states of the generative AI model. In this way, the server implements a non-conventional, rule-based gate around the generative AI output, improving safety and determinism of the overall system. In one embodiment, when the use of the information processing resource is permitted, the server processes documents containing configuration information. The server obtains image data representing instruction sheets or manuals by reading digital files from a storage device or by receiving image data over a network. The server calls a character recognition algorithm, which may be an OCR engine, and passes the image data to the OCR engine through a defined interface. The OCR engine processes pixel data, segments characters or lines, and outputs recognized text along with positional information. The server receives this output and executes a parsing routine that identifies key-value patterns such as “Machine ID: XXXX”, “Speed=NN”, or “Temperature: TT° C.”. The server stores the extracted configuration information as structured data, for example as rows in a parameter table or as key-value pairs in a schema-defined record.

In one embodiment, the server integrates structured configuration information with past work history data to generate guidance content. The guidance generation module creates an internal representation of the current configuration state, including machine identifiers, parameter ranges, and any constraints derived from prior executions. The server then generates a prompt sentence that instructs the generative AI model to produce stepwise instructions for a user. For example, the server may generate:
“Configuration information:
   Machine ID: RBT-01
   Recommended speed: 60
   Temperature range: 65-72° C.

Generate step-by-step guidance for a human operator to configure Machine RBT-01 according to the above parameters, including safety checks and confirmation steps. Output a numbered list of concise steps.”

The server sends this prompt sentence to the generative AI model, receives guidance content, and then renders the content for presentation on a user information terminal. By delegating the natural language formulation to the generative AI model while preserving parameter-level control in the server, the system separates semantic generation from deterministic constraint enforcement. This architecture reduces the need for manually authored instruction templates and improves adaptability to new machine types or parameter sets.

In one embodiment, the server generates work instruction information for an automated work apparatus based on past work history data and consultation content. The work instruction generation module selects relevant history records, including previous task sequences, parameter combinations, and observed outcomes such as defect rates or cycle times. The module encodes these records into a compact textual description and embeds them into a prompt sentence such as:
“Historical work data:
   Task: Assemble Product X with Robot A at speed 60, temperature 68-72° C., low defect rate.
   Task: Transfer parts with Robot B at conveyor speed 45, no jams.
   Safety constraints: Do not exceed speed 65 for Robot A; do not exceed conveyor speed 50 for Robot B.
Generate detailed, step-by-step work instructions for coordinating Robot A and Robot B on a mixed-product line while minimizing defects and avoiding jams. Output a numbered list of steps and include specific parameter values for speed and temperature.”

The server sends this prompt sentence to the generative AI model and receives work instruction information. The server parses the instructions to identify discrete tasks and associated parameters, and constructs a structured representation, such as a sequence of operation records with fields for apparatus identifier, action type, position, speed, and associated conditions.

In one embodiment, the server applies a dedicated evaluation module to the work instruction information. The server reads safety conditions and operational conditions from the database, including maximum speeds, allowable temperature ranges, and scheduling constraints. The evaluation module computes a feature vector for each instruction sequence, including maximum speed, cumulative thermal exposure, and timing intervals, and checks whether these features satisfy all constraints. When an instruction violates a constraint, the server either rejects the instruction or flags it for human review. Because the evaluation is performed using explicit threshold comparisons and deterministic rules rather than human visual inspection, the system improves the accuracy and speed of validation, and reduces the risk of inconsistent decision-making.

In one embodiment, the server translates validated work instruction information into control parameters for an automated work apparatus. The server contains a device abstraction layer that maps high-level parameters, such as “speed 60” or “temperature 70° C.,” to low-level register addresses or command codes specific to each apparatus type. The server communicates with the apparatus controller through an industrial communication protocol over a communication network. The server writes configuration values into specified control registers and transmits start commands, thereby causing the apparatus to perform physical operations such as moving actuators, heating elements, or conveyors. The direct coupling between AI-assisted planning and physical device control establishes a concrete technical effect beyond abstract data manipulation.

In one embodiment, the server communicates guidance information and work instruction information to a user information terminal. The server exposes a network interface that supports secure connections using a transport protocol. The server formats guidance content and instruction summaries as structured messages and transmits them to the terminal. The terminal executes a client application that parses the messages and updates user interface components. The terminal displays stepwise instructions, highlights parameter values, and may convert text to audio for spoken guidance. The terminal also presents interactive elements allowing the user to confirm completion of steps, report anomalies, or correct configuration proposals.

In one embodiment, the user operates the user information terminal to follow guidance content. The user visually inspects the automated work apparatus, confirms safety precautions, adjusts knobs or switches according to instructed values, and then provides confirmation through the terminal. The user may input feedback information when encountering unexpected behavior or when noticing discrepancies between actual apparatus behavior and the guidance. The terminal sends this feedback information to the server, which stores it in the database as part of history information.

In one embodiment, the server collects execution result information from automated work apparatuses. The server polls status registers or subscribes to event notifications via the industrial communication interface. The server stores error codes, completion states, cycle counts, and performance metrics in the database. The history management module aggregates these execution results with associated configuration information, consultation identifiers, and feedback information. The server then updates the aggregated data into normalized records that can be efficiently retrieved and embedded into future prompt sentences.

This integrated architecture yields several technical effects. The use of structured history information and explicit evaluation conditions enables the server to generate targeted prompt sentences that condition the generative AI model on context-relevant data while keeping the prompt length within model constraints. This reduces communication payload size and model computation, thereby lowering latency and network load. The deterministic evaluation of generative outputs against safety and operational conditions reduces the need for manual review, improves consistency, and decreases error rates in apparatus configuration. The systematic storage and reuse of execution result information and feedback information improves the efficiency of subsequent computations by avoiding repeated ad hoc analysis.

The system also improves computer technology itself by introducing a non-conventional orchestration of the generative AI model via multiple specialized prompt sentences for distinct purposes (consultation generation, AI-use evaluation, guidance generation, and work instruction generation), combined with a separate deterministic evaluation layer and device-control layer. This separation of concerns allows the processor to exploit the generative capabilities of the model while constraining its outputs through explicit algorithms and data structures. Compared to a simple automation of human decision-making, the system implements optimized data flows, structured representations, and safety-enforcing algorithms that are specifically adapted to the characteristics of the generative AI model and the controlled apparatuses.

Alternative embodiments are possible. In one embodiment, the generative AI model is executed on a local accelerator device attached to the server, and the prompt sentences are exchanged through an inter-process communication channel. In another embodiment, the server uses a different neural network architecture, such as a recurrent neural network or a hybrid transformer-convolutional network, provided the architecture accepts tokenized prompt sentences and produces tokenized textual outputs. In still another embodiment, the character recognition algorithm uses a convolutional neural network trained on industrial documents, and the OCR output includes confidence scores used by the server to decide whether to request additional user confirmation for low-confidence fields. In a further embodiment, the evaluation conditions and safety conditions are learned or refined using machine-learning models trained on historical violations and safe operations, and the server combines rule-based checks with predicted risk scores to improve detection of problematic instructions.

In all embodiments, the server coordinates generative AI processing, deterministic evaluation, structured history management, and apparatus control in a unified framework. This coordination results in improved processing speed due to reduced redundant computations, improved accuracy due to systematic constraint checks and structured data handling, and reduced communication overhead due to compact, context-specific prompt sentences and responses. Consequently, the invention provides a concrete improvement in the functioning of computer systems used for managing AI-assisted workflows and controlling automated work apparatuses.

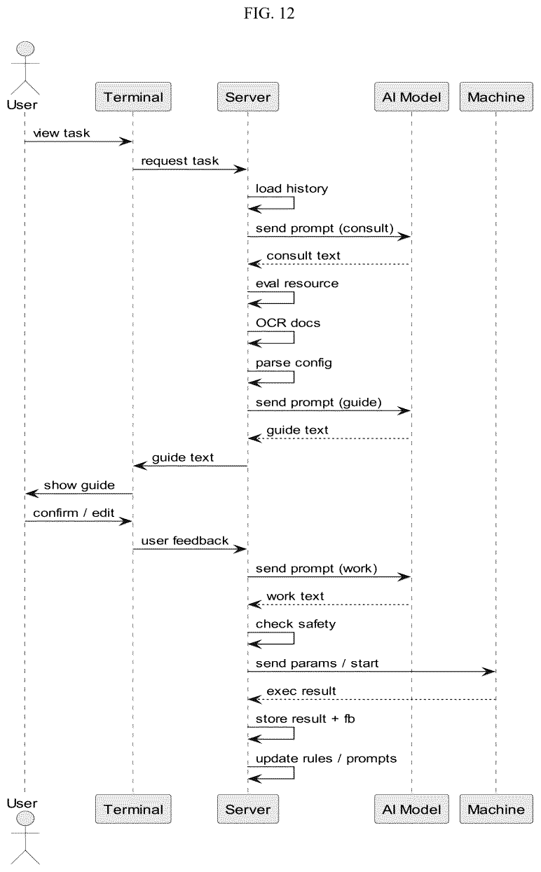

The following describes the processing flow using FIG. 12.

### Step 1:

Server retrieves past information from a storage device and converts it into structured input data. Server uses a database driver to execute a query that selects past consultation logs, past work history records, and relevant configuration records from multiple tables. Server receives the query result as rows, and converts each row into an in-memory structure with fields such as timestamp, machine identifier, parameter name, parameter value, and outcome indicator.
Input: raw database tables storing past consultations, work histories, and configurations.
Output: an aggregated data structure in memory (for example, a list of records) representing past information normalized by machine and task.

Server performs data aggregation by grouping records by consultation identifier and machine identifier, sorting by timestamp, and discarding obsolete or duplicated entries. Server also computes simple statistics, such as average speed or defect rate, by applying arithmetic operations to parameter values.

### Step 2:

Server generates a prompt sentence for a generative AI model based on the structured past information.

Server selects a subset of the past information relevant to a target machine or task, and converts these records into textual descriptions using string formatting. Server concatenates fixed template strings (for example, “Past ISC consultations: \n”) with the textual descriptions, and appends an instruction asking for new consultation content or work instructions.
Input: structured past information for selected machines and tasks.
Output: a prompt sentence in natural language formatted as a single text string.

Server performs data processing by mapping field names to human-readable labels, inserting parameter values into the template, and limiting the total length of the prompt sentence according to a token budget estimated from the number of characters.

### Step 3:

Server transmits the prompt sentence to the generative AI model and receives generated consultation content or work instruction information.

Server tokenizes the prompt sentence using a tokenizer compatible with the generative AI model, converting the text string into a sequence of token identifiers. Server sends the token sequence to the generative AI model via an interface, receives probability distributions over output tokens at each generation step, and decodes these distributions into an output token sequence using a decoding strategy. Server reconstructs the output token sequence into an output text string.
Input: prompt sentence text and corresponding token sequence.
Output: generated output text from the generative AI model representing consultation content or candidate work instructions.

Server performs numerical computation when the generative AI model applies linear transformations, attention mechanisms, and non-linear activations to the token embeddings, and performs selection of output tokens by comparing probabilities and applying thresholding or sampling rules.

### Step 4:

Server evaluates whether use of an information processing resource is permitted based on the generated consultation content.

Server parses the consultation content to identify suggested parameters, recommended actions, and risk descriptions by searching for predefined keywords and patterns. Server retrieves evaluation conditions from a configuration dataset that specifies allowed operations, prohibited terms, and safety thresholds. Server compares extracted parameter values with threshold values and scans for prohibited phrases.
Input: generated consultation content text and stored evaluation conditions.
Output: an evaluation result flag indicating “permitted” or “not permitted,” and a list of detected violations if any.

Server performs logical operations by evaluating conditional expressions, such as “if speed>maximum_allowed_speed then flag violation,” and aggregates Boolean results into a single decision flag via AND/OR operations.

### Step 5:

Server processes document image data to extract configuration information when use of the information processing resource is permitted.

Server receives image files representing instruction sheets or manuals from a file storage or through a network. Server passes the image data to a character recognition algorithm, which outputs recognized text and positional metadata. Server parses the recognized text to detect patterns such as “Machine ID:”, “Speed=”, or “Temperature:”, and extracts the corresponding values.
Input: image data for documents and permission flag from the evaluation step.
Output: structured configuration information, including machine identifiers and parameter values encoded as key-value pairs.

Server performs image-to-text conversion via the OCR engine, string processing to isolate parameter lines, and data type conversion to transform recognized numeric strings into integer or floating-point values.

### Step 6:

Server integrates configuration information with past work history data to prepare guidance content. Server links configuration entries to corresponding machines and tasks by matching machine identifiers with records in the work history tables. Server computes derived parameters, such as recommended ranges or default values, by combining configuration information with historical statistics (for example, typical speeds with low defect rates). Server then constructs an internal representation that associates each parameter with both current values and historical context.
Input: structured configuration information and past work history data.
Output: an integrated configuration-and-history dataset suitable for generating user guidance.

Server performs join operations on identifiers, computes averages, min/max values, and determines whether current parameters fall within historical safe ranges using comparison operations.

### Step 7:

Server generates a prompt sentence for the generative AI model to obtain stepwise guidance content for the user.

Server converts the integrated configuration-and-history dataset into human-readable bullet points or lines, and embeds these in a guidance template. Server then appends an instruction asking the generative AI model to produce numbered, step-by-step instructions that a user can follow.
Input: integrated configuration-and-history dataset.
Output: a guidance-generation prompt sentence in natural language.

Server performs string construction by concatenating fixed instructions such as “Generate step-by-step guidance for a human operator to configure the machine as follows:” with parameter lines, and ensures that each parameter is expressed in units understandable to the user (for example, “C” for temperature).

### Step 8:

Server transmits the guidance-generation prompt sentence to the generative AI model and receives guidance content.

Server tokenizes the guidance-generation prompt, sends it to the generative AI model, and decodes the model's output into text, similarly to the earlier generation step. Server obtains guidance content consisting of numbered steps, warnings, and confirmation prompts for the user.
Input: guidance-generation prompt sentence.
Output: guidance content text suitable for user presentation.

Server converts token sequences to text using a mapping table and removes any extraneous symbols or incomplete sentences by applying post-processing rules that ensure the guidance ends at a complete step boundary.

### Step 9:

Server generates a prompt sentence for the generative AI model to obtain new work instruction information for an automated work apparatus.

Server selects relevant past work history records and consultation content, and encodes them into a compact description emphasizing task sequences and parameter ranges. Server inserts this description into a work-instruction template and adds explicit constraints such as “do not exceed speed X” or “avoid temperature above Y.”
Input: past work history records and consultation content.
Output: a work-instruction-generation prompt sentence in natural language.

Server performs summarization by selecting a limited number of key records, merges similar tasks by averaging or taking representative values, and formats the summary as short lines embedded within the prompt sentence.

### Step 10:

Server transmits the work-instruction-generation prompt sentence to the generative AI model and receives work instruction information.

Server sends the tokenized prompt to the generative AI model, receives output tokens, and decodes them into a sequence of instructions that specify apparatus actions, parameter values, and ordering constraints.
Input: work-instruction-generation prompt sentence.
Output: generated work instruction information in text form.

Server transforms the text into a structured representation by splitting on numbered steps or specific markers, and assigning each step attributes such as action type, target device, and parameter values extracted via pattern matching.

### Step 11:

Server evaluates the appropriateness of the work instruction information against safety and operational conditions.

Server loads safety limits, operational constraints, and scheduling requirements from configuration datasets. Server computes a feature vector for each instruction step, including maximum requested speed, cumulative operation time, and temperature profiles, by reading parameter values from the structured representation. Server compares these features against stored thresholds and flags any violations.
Input: structured work instruction information and stored safety and operational conditions.
Output: an evaluation result including an “instruction_ok” flag and a list of violations or warnings.

Server performs numerical comparisons, sums or multiplies parameters to estimate workload or thermal exposure, and applies rule-based logic to decide whether the instruction sequence is acceptable for automatic execution.

### Step 12:

Server converts validated work instruction information into machine-specific control parameters for an automated work apparatus.

Server uses a device abstraction layer that maps logical actions (for example, “move arm to position P at speed S”) to physical control signals such as register values or command frames. Server encodes speeds, positions, and temperatures into numeric fields according to the protocol specification of the apparatus controller.
Input: validated work instruction information and device capability definitions.
Output: a set of control parameters and command messages formatted for transmission to the automated work apparatus.

Server performs scaling and quantization of parameters, for example converting human-readable speed units to internal units, and constructs communication packets with headers, payloads, and checksums as required by the industrial communication protocol.

### Step 13:

Server transmits control parameters to the automated work apparatus and initiates execution, while the terminal prepares to present guidance.

Server opens a communication session with the automated work apparatus over a communication network and sends the control parameter messages to the controller. Server receives acknowledgments confirming that parameters have been written to control registers. In parallel, server packages guidance content and a summary of the work instructions into messages destined for the user information terminal.
Input: control parameters, guidance content, and work instruction summaries.
Output: parameter transmission status, apparatus start command, and network messages containing guidance information for the terminal.

Server processes acknowledgment codes, updates internal status flags (such as “machine_configured” and “run_started”), and writes log entries recording the exact control parameters sent and the time of transmission.

### Step 14:

Terminal receives guidance information and displays or outputs it to the user.

Terminal establishes a secure connection to the server, requests guidance information for a specific machine or task, and receives a message containing the guidance content and work instruction summary. Terminal parses the message, extracts the stepwise guidance, and renders it on a graphical user interface as a list of steps, each with checkboxes or buttons for confirmation. Terminal may additionally send the guidance text to a text-to-speech module to generate audio output.
Input: guidance information message from the server.
Output: visual and/or audio presentation of the guidance steps to the user.

Terminal performs parsing of structured fields, updates displayed components on the screen, and records user interactions such as button presses in local memory for later transmission.

### Step 15:

User follows the guidance and inputs confirmations or corrections via the terminal.

User observes the displayed steps, physically interacts with the automated work apparatus by adjusting settings or verifying states, and then operates the terminal to mark each step as completed or to correct any mismatched parameter suggestions. User may type comments describing anomalies or suggestions for improvement.
Input: guidance display and apparatus state as perceived by the user.
Output: user interaction data including confirmations, corrections, and textual comments.

User performs data entry operations such as tapping, typing, and selecting options, and the terminal encodes these actions as event records.

### Step 16:

Terminal transmits user feedback information to the server.

Terminal collects interaction events and composes a feedback message containing step identifiers, completion flags, corrected parameter values, and comments. Terminal sends this message to the server over the communication network.
Input: user interaction data collected on the terminal.
Output: feedback message transmitted to the server for processing and storage.

Terminal performs serialization of feedback structures into a message format, handles retransmissions if necessary, and updates its local state to indicate that feedback has been sent.

### Step 17:

Server stores execution result information and feedback information as history information and prepares them for future use.

Server receives feedback messages from the terminal and status messages from the automated work apparatus, including execution result codes, cycle counts, and performance metrics. Server writes these data into dedicated tables in the storage device, associating each record with machine identifiers, consultation identifiers, and instruction identifiers. Server then applies normalization and indexing to ensure that the new records can be efficiently retrieved.
Input: execution result messages from the apparatus and feedback messages from the terminal.
Output: updated history information stored in the database and indexed by relevant keys.

Server computes derived statistics, such as average completion time per step and defect rates under particular parameter combinations, and stores these as aggregated fields. Server also tags certain records (for example, those containing safety-related comments) for prioritized retrieval in subsequent prompt construction.

### Step 18:

Server updates internal models and prompt-generation strategies based on accumulated history information.

Server analyzes the history information to identify patterns such as frequently corrected parameters or recurrent violations. Server adjusts evaluation conditions, safety thresholds, or prompt templates accordingly. For instance, server may modify a template to explicitly warn about a parameter range that historically caused issues.
Input: accumulated history information and aggregated statistics.
Output: updated evaluation conditions, safety constraints, and prompt templates stored in configuration datasets.

Server performs statistical analysis, such as computing frequency counts and correlations, and rewrites parts of the prompt templates by inserting new warning lines or additional context fields. This adaptive modification of prompts and conditions enhances the quality and safety of future generative AI outputs.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented configuration support systems suffer from several technical limitations when attempting to guide a user through initial setup of an information processing environment. In many existing systems, past operational logs or consultation histories are either not utilized at all, or are used in a static, rule-based manner that does not scale well as the volume and diversity of historical data increase. As a result, the computing resources of the system are not effectively leveraged to generate adaptive guidance, and the system cannot efficiently produce consultation content that reflects current patterns and trends in configuration issues. Furthermore, in typical systems, the processing pipeline from generation of consultation content to extraction of configuration information from documents is fragmented. For example, a system may separately perform character recognition on manuals or setup documents, but does not computationally couple such recognition with dynamically generated consultation content. This separation forces a human operator or external application to manually bridge the gap between generated consultation advice and low-level configuration parameters, which increases latency, processing overhead, and the likelihood of errors in mapping recognized text to actionable configuration values.

In addition, the evaluation of automatically generated consultation content is often rudimentary or absent. Many systems either trust the output of an automated text generator without substantive automated checking, or rely on fixed filters that are not aligned with the actual usage patterns and constraints of the underlying computing environment. Such inadequate evaluation mechanisms can lead to guidance that is unsafe, irrelevant, or inconsistent with the system's technical requirements, potentially causing misconfigurations, service interruptions, or security vulnerabilities.

Moreover, existing systems generally provide user interfaces that are not tightly synchronized with underlying configuration data structures. Even when configuration information is extracted from documents, it is commonly presented to the user as unstructured text or generic forms, without a structured mapping to navigation logic that can be automatically adjusted based on the recognized parameters and their interdependencies. This disconnect results in inefficient user interactions, increased cognitive load on the user, and repeated network communications between a client device and a server as the user alternates between guidance text, manual interpretation, and input screens. From a computer-technology standpoint, these limitations manifest as suboptimal use of processing resources, excessive data transfer, redundant parsing operations, and an inability to systematically adapt the behavior of the server and the client device to the characteristics of past data and recognized document content. There is therefore a need for a system that improves the way a processor orchestrates generative AI inference, evaluation logic, optical character recognition processing, and structured navigation generation, in order to reduce processing complexity, improve consistency of configuration workflows, and enhance the overall performance and reliability of the configuration support functions.

Accordingly, one technical problem to be solved by the present invention is to provide a computer-implemented mechanism that: (i) systematically uses past information as input to a generative AI model through a controlled prompt sentence; (ii) evaluates the generated consultation content on the server side using reference information and pattern recognition; (iii) tightly integrates such evaluated content with document-based configuration extraction using character recognition techniques; and (iv) automatically generates structured navigation information and user guidance in a manner that reduces manual intervention and improves the efficiency and robustness of configuration operations on the client side.

The specific processing by the specific processing unit 290 of the data processing device 12 in Example 2 is realized by the following means.

The present invention provides a server comprising a processor and a memory storing instructions which, when executed by the processor, cause the processor to acquire past information stored in a storage device, generate a prompt sentence including the past information as input data to be provided to a generative AI model, and transmit the prompt sentence to the generative AI model so that consultation content is generated; apply, to consultation content output from the generative AI model, an evaluation algorithm based on reference information to determine usability of the consultation content, and control recording of the consultation content in the storage device or re-generation of the consultation content in accordance with a result of the determination; obtain document data associated with consultation content determined to be usable, extract character information from the document data by using an optical character recognition technique, and perform analysis based on pattern matching or natural language processing on the character information to extract configuration information relating to system settings; format the extracted configuration information as structured data, generate, based on the structured data, a prompt sentence including guide information for providing stepwise setting operations to a user terminal, input the prompt sentence to the generative AI model so that user guidance text is generated, and transmit the user guidance text and the configuration information to the user terminal; and receive setting values transmitted from the user terminal, verify the setting values by comparing the setting values with the configuration information, and update system configuration information based on a result of the verification to set a usage-start state of the system. This enables a technically integrated processing pipeline in which server-side control of prompt sentences for the generative AI model, automated evaluation of generated consultation content, OCR-based extraction and structuring of configuration parameters, and generation of navigation information for the user terminal cooperate to reduce computational redundancy, improve consistency and reliability of configuration workflows, and enhance the efficiency of user interaction within the computer system.

The term “past information” refers to data previously accumulated in one or more storage devices, including but not limited to historical consultation records, operational logs, configuration histories, and associated metadata, which are used as input data for subsequent processing.

The term “storage device” refers to a hardware or virtualized component capable of non-transitory storage of digital data, such as a magnetic disk, solid-state drive, optical medium, or network-accessible storage resource.

The term “prompt sentence” refers to a machine-readable instruction string, including one or more natural language or structured language expressions, that is supplied as input to a generative AI model to control or constrain the content, style, or structure of an output generated by the generative AI model.

The term “generative AI model” refers to a trained computational model, such as a neural network or other machine learning model, that generates output data including natural language text in response to an input, such as a prompt sentence, based on statistical patterns learned from training data.

The term “consultation content” refers to text or structured information generated by the generative AI model that describes, explains, or advises on configuration, troubleshooting, or usage of an information processing system.

The term “reference information” refers to rule sets, thresholds, policies, criteria, or other predefined data stored in a storage device and used by an evaluation algorithm to assess the usability or appropriateness of consultation content.

The term “evaluation algorithm” refers to a sequence of computational steps, including rule-based processing, pattern recognition, or statistical analysis, executed by a processor to determine whether generated consultation content satisfies reference information and is suitable for use.

The term “usability of the consultation content” refers to a determination, based on the evaluation algorithm and reference information, that the consultation content conforms to one or more criteria such as relevance, safety, completeness, and consistency with system requirements.

The term “document data” refers to electronic representations of documents, including image data, page data, or file data such as raster images or page-description formats, that contain text describing system settings, configuration procedures, or technical specifications.

The term “optical character recognition technique” refers to a computational process that analyzes image data representing text, detects character shapes, and outputs corresponding machine-readable character codes.

The term “character information” refers to machine-readable text data obtained by applying the optical character recognition technique to document data, including characters, words, and sentences recognized from images.

The term “pattern matching” refers to a computational process that compares character information against predefined patterns, such as regular expressions or templates, to identify occurrences of specific strings, formats, or structures.

The term “natural language processing” refers to a set of computational techniques that analyze and process human-readable language, including tokenization, part-of-speech tagging, entity recognition, syntactic parsing, and semantic analysis.

The term “configuration information” refers to data elements that define or affect the operational parameters of an information processing system, including, for example, network addresses, port numbers, authentication methods, user privilege levels, and policy settings.

The term “system settings” refers to a collection of configuration information that determines the behavior, connectivity, security, or functional operation of an information processing system.

The term “structured data” refers to data organized according to a predefined schema or format, such as key-value pairs, tables, or hierarchical objects, that enables systematic access, interpretation, and processing by a computer.

The term “guide information” refers to information including instructions, explanations, step descriptions, and recommended actions that are intended to direct a user through one or more configuration or operation procedures.

The term “user terminal” refers to an end-user computing apparatus, such as a client computer, mobile device, or dedicated terminal, that communicates with a server and presents information to a user and receives input from the user.

The term “user guidance text” refers to text generated by the generative AI model based on a prompt sentence including guide information, the text being intended to be displayed on a user terminal to assist the user in performing configuration or operation steps.

The term “setting values” refers to specific input values, such as parameter values or option selections, transmitted from the user terminal to the server in response to guidance, and intended to be applied to the configuration of the system.

The term “system configuration information” refers to a set of data records stored in one or more storage devices that collectively define the current configuration state of the system, including active parameters and their relationships.

The term “usage-start state” refers to a state of the system in which required configuration information has been validated and applied, and in which the system is enabled to perform its intended operational functions for a user.

The term “pattern recognition processing” refers to computational processing that detects and identifies recurring structures or features in data, such as clusters, sequences, or correlations, using methods including statistical analysis or machine learning.

The term “feature information” refers to information representing characteristics or attributes extracted from data by pattern recognition processing, which can be used to adjust or refine the structure of consultation content or evaluation criteria.

The term “configuration item group” refers to a logical grouping of configuration information items that share a common purpose or domain, such as network settings, authentication settings, user privilege settings, or error handling settings.

The term “step information” refers to data describing a discrete step in a configuration or operation procedure, including one or more input items, recommended values, and confirmation procedures associated with that step.

The term “navigation information” refers to data defining control of screen transitions, input interfaces, and interaction flow on a user terminal, based on step information and configuration item groups, to guide a user through a sequence of operations.

The server constitutes an information processing apparatus that includes at least one processor, a memory, a network interface, and one or more storage devices. The server executes a program stored in the memory to perform control of a generative AI model, evaluation logic, optical character recognition processing, structured configuration extraction, and navigation generation. The terminal constitutes a client device such as a personal computer, a tablet device, or a handheld communication device including a display unit, an input unit, a processor, a memory, and a communication interface. The user operates the terminal to view guidance provided by the server and to input configuration values.

The server uses general-purpose computing hardware such as a central processing unit (CPU) and, in some embodiments, a graphics processing unit (GPU) to perform parallel numerical computation for neural network inference. The server uses an operating system such as a UNIX-based system, a database management system such as a relational database, an application framework such as an HTTP server and a scripting runtime, an optical character recognition library such as a software OCR engine, and a generative AI model implemented as a neural network.

The server stores past information in a storage device as structured records. The server represents each past consultation record as a data structure including, for example, a consultation identifier, time information, a textual description of a past configuration issue, a resolution description, and classification labels such as a configuration domain and an error category. The server stores these records in tables with defined schemas. The server performs indexed queries over these tables to retrieve subsets of past information applicable to a particular configuration scenario.

The server uses a generative AI model that is implemented as a parameterized neural network, for example a transformer-based sequence model. The server stores model parameters such as weight matrices, bias vectors, and normalization parameters in a model storage area. The server uses a tokenization component to convert natural language strings into sequences of discrete tokens. The server applies an embedding layer that maps each token into a high-dimensional numeric vector. The server applies multiple attention layers that compute context-dependent representations by performing matrix multiplications, scaled dot products, and nonlinear activation functions. The server applies an output layer that maps the final hidden representations to probability distributions over possible next tokens. The server controls the generative AI model by specifying decoding parameters such as temperature, maximum output length, and probability cutoffs.

The server generates a prompt sentence as a structured string that controls operation of the generative AI model. The server selects multiple past consultation records according to predefined criteria, such as a similarity measure between a current configuration context and historical context based on vectorized representations. The server converts the selected records into text snippets and concatenates them with instruction text. The server, for example, generates a prompt sentence such as:
“Based on the following past ISC consultation data, please generate new consultation content that can be used to guide a new user through initial system setup.
Requirements:
1. Focus on configuration steps for network and account settings.
2. Avoid any real personal data or confidential information.
3. Output clearly structured questions and answers.”
The server may also generate alternative prompt sentences such as:
“Based on the following past ISC consultation data, please generate new consultation content that explains and guides initial network and account configuration for a new user. Provide questions, suggested answers, and important warnings.”
“Using historical ISC consultation logs related to system onboarding, generate a new consultation scenario that walks a user step-by-step through setting server URLs, ports, authentication methods, and default roles. Avoid any real customer names.”

The server assembles these prompt sentences with delimiting markers that distinguish instruction portions, contextual examples, and format requirements. The server then provides the prompt sentence to the generative AI model as input.

The server processes the output of the generative AI model as consultation content. The server receives the generated text, which consists of tokens generated one by one by the decoding procedure of the model. The server post-processes the text by detecting section markers, questions, and answers using simple parsing rules and regular expressions. The server stores the consultation content in the storage device together with an association to the used prompt sentence and the underlying past information identifiers. The server thereby creates an audit trail that links generated content to its computational provenance.

The server applies an evaluation algorithm that uses reference information stored in configuration tables. The server defines a set of evaluation rules such as length constraints, forbidden term lists, required section headers, and domain-specific constraints. The server represents these rules as data structures that include pattern strings, numerical thresholds, and rule actions. The server tokenizes the consultation content and iterates over tokens, comparing them to forbidden patterns. The server checks numerical metrics such as the number of questions, the ratio of guidance text to example text, and the presence of required disclaimers.

The server also uses pattern recognition processing implemented as a machine learning classifier to compute feature information for the consultation content. The server may, for example, use a smaller neural network model or a gradient-boosted decision tree model trained on labeled consultation texts. The server extracts features such as n-gram counts, sentence length distributions, topic vectors derived from an embedding network, and frequency of technical terms. The server applies the classifier to produce scores such as a relevance score and a safety score. The server compares these scores to threshold values stored in reference information. The server combines rule-based results and classifier scores to decide whether the consultation content is usable.

The server, when the consultation content is determined to be unusable, may generate a modified prompt sentence that includes additional constraints or error messages, and then re-invoke the generative AI model. The server thereby constructs a feedback loop that systematically improves the quality of generated consultation content by adjusting parameters and constraints rather than merely repeating the same input. This iterative control of prompt sentences provides a technical improvement in the interaction between the server and the generative AI model, leading to fewer rejections and reduced resource consumption.

The server constructs and trains the generative AI model by using a corpus of historical consultation logs. The server divides the corpus into training, validation, and test sets. The server uses a loss function such as cross-entropy to measure prediction error of next tokens. The server uses a gradient-based optimization algorithm such as stochastic gradient descent or an adaptive variant to update model weights. The server may apply regularization techniques such as dropout and weight decay. The server may perform data augmentation by paraphrasing sentences, shuffling non-critical sections, or injecting noise within controlled bounds, thereby improving robustness of the model to varied input patterns. As a result, the model is specifically optimized for consultation text generation within the configuration domain, improving accuracy and reducing hallucinations compared to a general-purpose language model.

The server obtains document data that is associated with the approved consultation content. The server maintains a mapping between configuration domains and file identifiers stored in a document repository. The server accesses documents such as digital manuals, specification sheets, and configuration guides stored in file systems or object storage. The server converts each document into a set of images when necessary, for instance by rendering each page of a vector-based document into a bitmap image. The server passes each image to an optical character recognition engine.

The server uses an OCR engine that applies image preprocessing, character segmentation, and character classification. The server applies pre-processing operations such as binarization, skew correction, and noise reduction to improve recognition accuracy. The server segments text lines and characters using connected-component analysis and projection profiles. The server classifies characters by comparing features derived from pixel neighborhoods to pre-trained models for character shapes. The server outputs recognized characters as machine-readable text. The server stores page-level text and position metadata for later contextual analysis.

The server performs text analysis on the OCR output to extract configuration information. The server defines regular expression patterns for typical configuration formats such as internet protocol addresses, uniform resource locator strings, port numbers, and structured identifiers. The server scans the text for these patterns and extracts candidate values. The server applies natural language processing techniques such as part-of-speech tagging and named-entity recognition to detect configuration labels such as “Server URL,” “Port,” “Authentication Method,” “Proxy Server,” “Default Role,” and “Password Policy.” The server groups labels and values into configuration item groups including at least network settings, authentication settings, user privilege settings, and error handling settings.

The server normalizes extracted configuration values by applying format checks and transformations. The server ensures that IP addresses conform to dotted decimal notation and that port numbers fall within a predefined range. The server converts textual boolean expressions such as “required” or “not required” into logical variables. The server represents all configuration information as structured data objects, for example as records with key fields, value fields, type descriptors, and relation pointers, and stores these objects in configuration tables.

The server generates guide information that maps structured configuration information to step information. The server defines, for each configuration item group, a sequence of steps, each step including input items, recommended values, and confirmation procedures. The server associates each input item with attributes such as data type, allowed range, default value, and validation rules. The server maps configuration dependencies, for example linking the availability of a particular authentication method to the presence of a given network setting. The server records this mapping in a navigation information structure that can be interpreted by the terminal.

The server generates a prompt sentence for the generative AI model that includes guide information and explicit formatting requirements for user guidance text. The server may, for example, generate a prompt sentence such as:
“Generate user guidance text for the following configuration steps.
Step 1: Confirm the server URL (default: https://example-isc-server.com).
Step 2: Confirm the port number (default: 443).
Step 3: Select an authentication method (options: Password, Token, Single Sign-On).
For each step, explain why the setting is important and what the user should check. Use clear and concise language.”

The server provides this prompt sentence to the generative AI model and obtains user guidance text that is aligned with the structured configuration data and step information. The server sends both the user guidance text and the structured configuration information to the terminal.

The terminal receives navigation information, structured configuration information, and user guidance text from the server through a network connection. The terminal parses the received data and constructs user interface screens. The terminal displays stepwise guidance to the user, including instruction text, recommended values, and input fields. The terminal may pre-populate form fields with default values derived from the configuration information. The terminal locally validates input formats, for example by ensuring that entered text matches basic patterns for addresses and numeric ranges, before transmitting the input to the server.

The user views the guidance on the terminal display. The user reads explanations of configuration items and recommended values. The user may accept suggested values or modify them according to local conditions. The user inputs configuration values such as server addresses, port numbers, authentication options, and role settings through the terminal's input unit. The user confirms each step according to the guide information, thereby progressing through the configuration process. The server receives configuration values from the terminal and performs verification operations. The server compares received values with extracted configuration information and validation rules. The server may perform active checks such as testing network connectivity to the specified server URL, verifying authentication credentials with an authentication subsystem, or checking role settings against policy definitions. The server records verified configuration values into system configuration information. The server sets a usage-start state when required values are present and valid. The server may then initiate controlled activation procedures such as starting services, opening communication ports, or registering system components, thereby exerting control over physical computing resources and network communication pathways.

The use of a generative AI model in combination with structured prompt sentences, evaluation algorithms, and OCR-based configuration extraction yields technical improvements in the operation of the server and the terminal. The server reduces redundant computation by reusing structured past information and dynamically adjusting prompt sentences instead of regenerating guidance from scratch. The server improves processing accuracy by integrating pattern recognition processing with rule-based evaluation, thereby filtering unsuitable consultation content before it reaches the terminal. The server reduces communication overhead by aggregating navigation information and structured configuration data into compact data structures that allow the terminal to render multiple steps without repeated server queries. The server improves data management by storing links between historical consultations, generated content, recognized documents, and applied configuration states in an integrated schema, thereby enabling efficient retrieval and audit.

The server, by explicitly controlling the internal parameters and inputs of a transformer-based generative AI model and by coupling its output with deterministic OCR and parsing pipelines, does not merely automate human reading and writing tasks. The server modifies the behavior of the underlying computing system by adaptively adjusting evaluation thresholds, prompt parameters, and navigation structures in response to measured performance metrics and feedback. This results in lower error rates, faster convergence to acceptable consultation content, and consistent alignment between guidance text and actual system configuration parameters. The system therefore improves the functioning of the computer itself, in terms of resource utilization, processing speed, and reliability of configuration operations.

In one embodiment, the server executes all generative AI inference on dedicated GPU hardware, while OCR and evaluation algorithms execute on CPU cores, enabling parallelism between tasks and reducing overall setup latency. In another embodiment, the server uses a smaller on-premise model for preliminary content generation and a larger remote model for refinement only when necessary, thereby balancing computation cost and output quality. In another embodiment, the server stores intermediate evaluation results and feature information to predict, based on historical performance, which prompt structures and parameter settings yield high-quality consultation content, and preselects such settings before contacting the generative AI model, further improving efficiency.

The terminal may vary in implementation; for example, a desktop client application, a browser-based interface, or a mobile application can all function as the user terminal as long as they implement the navigation information interpretation and input transmission defined above. The server may also support multiple terminals concurrently, with each terminal session associated with its own configuration workflow and usage-start state.

In this way, the server, the terminal, and the user cooperate to implement the invention. The server coordinates complex internal processing flows involving generative AI inference, evaluation, OCR, structured extraction, and configuration verification. The terminal presents dynamic, stepwise guidance aligned with actual system parameters. The user provides final configuration decisions. Through this integrated design, the system provides a concrete implementation of the claimed invention that can be realized on general-purpose computing hardware and commonly available software components, while achieving technical improvements in processing efficiency, accuracy, and reliability of configuration operations.

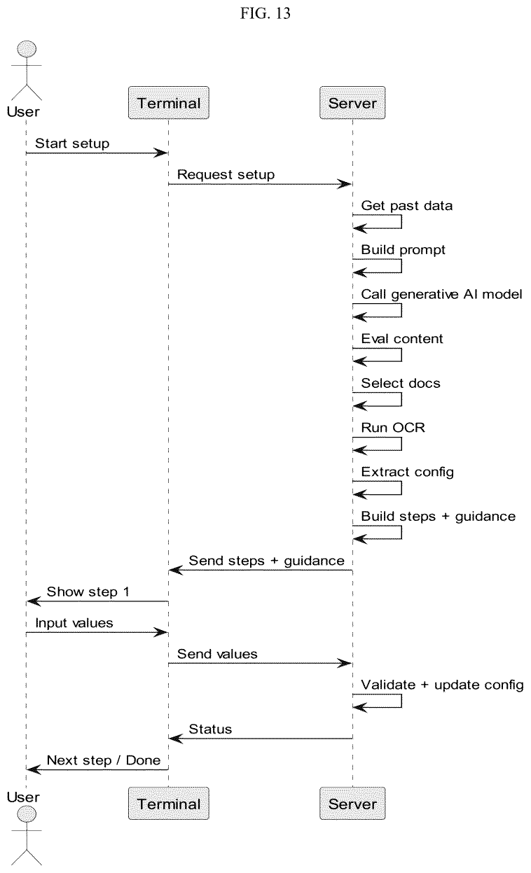

The following describes the processing flow using FIG. 13.

### Step 1:

The server acquires past information from a storage device. The server receives as input one or more identifiers for a target configuration scenario (for example, a scenario type such as “initial network and account setup”). The server executes database queries to retrieve past consultation records, including text fields, classification labels, and resolution results. The server performs data processing such as filtering by scenario type, time period, and quality flags, and normalizing text encoding and whitespace. As output, the server produces a structured collection of past consultation records ready to be used as context for generating a prompt sentence.

### Step 2:

The server generates a prompt sentence for a generative AI model based on the past information. The server takes as input the structured past consultation records from Step 1 and configuration parameters such as desired domain, length constraints, and style requirements. The server concatenates instruction text with selected example consultations, inserts requirement bullets, and adds delimiters to distinguish instructions from examples. The server performs string processing operations to build a single coherent prompt sentence, such as:
“Based on the following past ISC consultation data, please generate new consultation content that can be used to guide a new user through initial system setup.
Requirements:
1. Focus on configuration steps for network and account settings.
2. Avoid any real personal data or confidential information.
3. Output clearly structured questions and answers.”
As output, the server produces a completed prompt sentence string that will be passed to the generative AI model.

### Step 3:

The server calls the generative AI model with the prompt sentence and obtains consultation content. The server receives as input the prompt sentence from Step 2 and generation parameters such as maximum token length, temperature, and decoding strategy. The server tokenizes the prompt, sends the token sequence to the generative AI model, and initiates inference, wherein the model performs matrix multiplications, attention computations, and non-linear activation operations to predict successive output tokens. The server receives the generated token sequence and converts tokens back into a natural language string. As output, the server produces generated consultation content that includes questions, answers, and explanatory text.

### Step 4:

The server evaluates the generated consultation content using reference information and pattern recognition processing. The server takes as input the generated consultation content from Step 3 and evaluation parameters including rule sets, forbidden term lists, and trained classifier models. The server tokenizes the content, computes features such as n-gram frequencies and technical term counts, and compares tokens against forbidden term lists. The server applies a classifier (for example, a neural network or tree-based model) to the feature vector to obtain relevance and safety scores. The server then aggregates rule-check results and classifier scores to determine whether the consultation content is usable. As output, the server generates a usability decision flag (usable/not usable) and associated evaluation metrics.

### Step 5:

The server decides whether to reuse, store, or regenerate consultation content based on the evaluation result. The server receives as input the usability decision and evaluation metrics from Step 4 together with the generated consultation content. If the content is deemed unusable, the server modifies evaluation-related parameters and constructs a revised prompt sentence, for example by appending additional constraints or clarifying instructions. The server then loops back to Step 3 with the revised prompt. If the content is deemed usable, the server stores the consultation content and its evaluation metadata into the storage device. As output, the server produces either a stored, approved consultation record or an updated prompt sentence for regeneration.

The server selects document data associated with the approved consultation content. The server takes as input the approved consultation content and its domain classification (for example, network configuration, authentication configuration). The server queries a mapping table that associates domain classifications with document identifiers and file paths. The server retrieves document metadata and, if needed, fetches document files such as manuals or setup guides from a document repository. The server verifies file types and integrity. As output, the server produces a set of document data objects (for example, page streams or image sequences) that correspond to the approved consultation content.

### Step 7:

The server performs optical character recognition on the document data to obtain character information. The server receives as input the document data objects from Step 6. The server preprocesses each page image by applying binarization, de-skewing, and noise reduction algorithms. The server segments text regions and characters, then applies a trained OCR classifier to convert character shapes into character codes. The server combines recognized characters into lines and paragraphs, preserving page and position information. As output, the server generates OCR text data, consisting of machine-readable character information linked to document identifiers and page positions.

### Step 8:

The server extracts configuration information from the OCR text using pattern matching and natural language processing. The server takes as input the OCR text data from Step 7 and extraction rules such as regular expressions and label dictionaries. The server scans the text for patterns matching common configuration formats (for example, IP address patterns, URL patterns, port number patterns), and tags matched substrings as candidate configuration values. The server applies linguistic analysis to detect configuration labels (for example, “Server URL,” “Port,” “Authentication Method”) and associates labels with nearby candidate values by computing positional and semantic proximity. The server groups label-value pairs into configuration item groups (for example, network settings, authentication settings, user privilege settings, error handling settings). As output, the server produces structured configuration information organized into configuration item groups.

### Step 9:

The server normalizes and validates the extracted configuration information. The server receives as input the structured configuration information from Step 8. The server applies data-type-specific validation operations, such as verifying IP address syntax, ensuring ports fall within valid ranges, and checking that URLs contain required schemes. The server converts natural language descriptions (for example, “required” or “not required”) into normalized logical values. The server resolves conflicts between duplicate or inconsistent values by applying priority rules or selecting values from the most recent document versions. As output, the server produces validated, normalized configuration information suitable for direct application to a system configuration database.

### Step 10:

The server generates step information and navigation information for guiding the user through configuration. The server takes as input the normalized configuration information from Step 9 and rule data defining step sequences for each configuration item group. The server decomposes each configuration item group into discrete steps, each step including one or more input items, recommended values, and confirmation procedures. The server builds a navigation structure that specifies the order of steps, branching conditions, and for each step, the required display elements and input controls on the terminal. As output, the server produces navigation information consisting of step definitions and user interface metadata linked to configuration items.

### Step 11:

The server generates a prompt sentence for creating user guidance text and calls the generative AI model. The server receives as input the navigation information and configuration information from Step 10. The server constructs a prompt sentence containing explicit step descriptions and default values, for example:
“Generate user guidance text for the following configuration steps.
Step 1: Confirm the server URL (default: https://example-isc-server.com).
Step 2: Confirm the port number (default: 443).
Step 3: Select an authentication method (options: Password, Token, Single Sign-On).
For each step, explain why the setting is important and what the user should check. Use clear and concise language.”

The server sends this prompt sentence to the generative AI model, which processes tokenized input and generates explanatory guidance text for each step. As output, the server obtains user guidance text aligned with the navigation structure and configuration values.

### Step 12:

The server transmits guidance and navigation information to the terminal. The server takes as input the user guidance text and navigation information from Step 11 along with associated configuration information. The server serializes these data into a format suitable for transmission over a network and sends them to the terminal via a communication protocol. The server may compress the data or batch multiple steps together to reduce communication overhead. As output, the server delivers to the terminal a complete set of guidance text, step definitions, and recommended configuration values for the upcoming configuration session.

### Step 13:

The terminal receives the guidance and navigation information and prepares user interface screens. The terminal takes as input the transmitted data from Step 12. The terminal parses the navigation information to determine the number of steps, the order of the steps, and the required input fields for each step. The terminal instantiates screen objects or views corresponding to each step, embedding the user guidance text and default configuration values into text boxes, labels, and input fields. As output, the terminal produces a set of ready-to-display interface screens stored in memory.

### Step 14:

The terminal displays stepwise guidance and collects input from the user. The terminal receives as input the prepared interface screens from Step 13 and user interaction events. The terminal renders the first step on a display, showing guidance text, recommended values, and editable fields. The terminal monitors user actions such as keyboard input, selection from menus, and button presses. The terminal performs local checks on input formats (for example, basic pattern checks for addresses and numeric ranges) and updates internal data structures representing current user inputs. As output, the terminal maintains an updated set of user-entered configuration values for each step.

### Step 15:

The user operates the terminal to review and adjust configuration values. The user takes as input the displayed guidance text and suggested configuration values from Step 14. The user reads explanations for each setting, compares recommended values to the actual environment, and modifies values where necessary, such as changing the server URL, adjusting a port number, or choosing a different authentication method. The user confirms each step by activating a control element (for example, a “Next” or “Confirm” button). As output, the user supplies confirmed configuration values to the terminal for transmission.

### Step 16:

The terminal transmits confirmed configuration values to the server. The terminal receives as input the confirmed values for one or more steps from Step 15. The terminal aggregates these values into a request payload including identifiers for steps and configuration items, and sends the payload to the server using the communication interface. The terminal may batch multiple steps in a single transmission to reduce network round trips. As output, the terminal provides the server with a structured set of user-confirmed configuration values.

### Step 17:

The server verifies user-submitted configuration values and updates system configuration information. The server takes as input the transmitted configuration values from Step 16 and the validated configuration information and rules from Step 9. The server compares each user-submitted value against expected formats and allowed ranges and performs additional checks such as connectivity tests or policy consistency checks where applicable. The server records verified values in a configuration database, updating or inserting records as needed, and sets status flags for each configuration item. As output, the server produces an updated system configuration state and a verification result indicating whether the system is ready for usage.

### Step 18:

The server sets the usage-start state and notifies the terminal. The server receives as input the updated system configuration state from Step 17. If required items are valid and complete, the server sets a usage-start state flag and initiates activation processes such as starting services or enabling network endpoints. The server generates a status message describing the result (for example, success or specific configuration issues) and transmits this message to the terminal. As output, the server provides the terminal with confirmation that the system is ready for normal operation or with information necessary to correct remaining configuration problems.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional information assistance systems that use generative artificial intelligence models typically treat prompt generation, policy judgment, document parsing, and user interface guidance as loosely coupled and manually configured components. As a result, several technical problems arise in the implementation and operation of such systems on general-purpose computing hardware. First, a conventional system often requires application developers or operators to handcraft prompt sentences for each use case and each state of a user session. The prompts are usually static and are not systematically derived from structured past information, such as user tendency profiles, consultation histories, and usage logs. This causes suboptimal use of computational resources: the generative models are repeatedly invoked with incomplete or poorly contextualized prompts, leading to unstable output quality, increased re-try calls, and unnecessary processor and network load.

Second, existing systems generally separate the pipeline for content generation from the pipeline for compliance or policy judgment. In many cases, policy checks are implemented as an external, rule-based filter that is not coherently integrated into the generative AI workflow. This separation increases latency and complexity in the processor: generated outputs must be serialized, transferred, and re-parsed multiple times between modules, leading to additional memory copying, redundant natural language parsing, and complicated error handling. These inefficiencies degrade throughput and responsiveness when running on standard computing resources.

Third, systems that extract configuration or setup information from documents using optical character recognition techniques often do so in an ad hoc manner, independent of the generative AI layer. OCR output is typically provided as raw text, and the subsequent construction of stepwise guidance for the user interface relies on bespoke, rule-based templates. As the complexity of services and devices increases, maintaining such templates becomes difficult, and the processor must perform multiple text processing passes to transform OCR text into executable guidance flows. This results in higher CPU usage, memory consumption, and development overhead.

Fourth, conventional guidance systems usually ignore the user's emotional state or treat it as a superficial user-interface adaptation (such as changing colors or icons) that is not integrated into the core information generation pipeline. Emotion recognition components, if present, are often decoupled from the content generation engine. Consequently, changes in the user's emotional state do not directly affect how the prompts are constructed, how the generative model is invoked, or how the explanatory information is structured. This leads to repeated user confusion, increased time to task completion, and additional load on support infrastructure, which in turn reduces the overall efficiency of the computing system.

Fifth, existing systems typically do not feed back detailed operation history information and usage information of generated guidance into the generative AI prompt generation loop in a unified way. Logging is often used only for offline analytics, not as a structured input to automatically refine prompts and user tendency profiles. As a result, the processor cannot effectively adapt its prompt construction and decision logic over time, forcing engineers to manually tune parameters and rules. This lack of autonomous adaptation impairs scalability and wastes computing resources when the system is deployed to large user populations.

Therefore, there is a need for a technical mechanism that, on a computing system including a processor, integrates: (i) statistical analysis of past information to compute user tendency information, (ii) automatic construction of multiple types of prompt sentences for a generative AI model, (iii) in-line judgment of information technology usability and quality evaluation within the generative workflow, (iv) structured extraction of setting information from documents using optical character recognition techniques, and (v) emotion-aware correction of explanatory information, all while tightly coupling these components with logging and feedback of operation history. Such integration should improve the efficiency, robustness, and adaptability of the overall information processing pipeline on a general-purpose processor.

The specific processing by the specific processing unit 290 of the data processing device 12 in Application Example 2 is realized by the following means.

The present invention provides a server comprising a processor configured to receive past information as input data and perform statistical analysis on the input data to generate tendency information of a user; generate a prompt sentence for generating consultation content or recommendation target information based on the tendency information of the user and consultation history information included in the past information, and input the prompt sentence to a generative artificial intelligence model to generate the consultation content or the recommendation target information; generate a prompt sentence for determining usability of an information technology or information processing based on the generated consultation content or the recommendation target information, input the prompt sentence to the generative artificial intelligence model to determine the usability, and select the consultation content or the recommendation target information according to a result of the determination of the usability; extract setting information from document data by using an optical character recognition technique when use of the information technology or the information processing is determined to be allowable, and generate structured data including the extracted setting information; generate a prompt sentence for generating explanatory information for stepwise guiding a user to perform a setting operation or a service start procedure based on the structured data, and input the prompt sentence to the generative artificial intelligence model to generate the explanatory information; analyze facial information or voice information of the user to estimate an emotional state of the user, generate a prompt sentence for changing a degree of detail or an expression style of the explanatory information according to the emotional state, and input the prompt sentence to the generative artificial intelligence model to correct the explanatory information; and transmit the corrected explanatory information and the selected recommendation target information to a user terminal for display at the user terminal. This enables an integrated information processing pipeline in which the processor automatically derives multiple types of prompt sentences from structured past information, document-derived setting information, and real-time emotion states, thereby reducing redundant processing, improving the quality and policy compliance of generated content, dynamically adapting guidance to user behavior and emotion, and enhancing overall efficiency and scalability of the computer-implemented assistance system.

The term “processor” refers to a hardware computation unit or a set of hardware computation units, such as a central processing unit, a graphics processing unit, or a specialized accelerator, configured to execute instructions to perform information processing.

The term “past information” refers to stored data representing historical states or events related to a user or a system, including but not limited to viewing histories, consultation records, operation logs, and usage statistics, which are used as input for subsequent analysis or generation.

The term “input data” refers to data supplied to the processor or to a processing module as a starting point for computation, analysis, or generation, including past information, real-time user inputs, and sensor-derived signals.

The term “statistical analysis” refers to a class of computational techniques in which numerical or categorical data are aggregated, measured, or modeled, including operations such as counting, averaging, clustering, or probability estimation, in order to derive characteristic values or patterns from the input data.

The term “tendency information of a user” refers to information indicating one or more preferences, habits, or behavioral patterns of a user, derived from past information and represented in a structured or quantified form.

The term “consultation history information” refers to data representing past consultation interactions, including previous questions, answers, recommendations, and associated context or outcomes, stored for later reference and analysis.

The term “consultation content” refers to generated information that provides advice, guidance, or suggested actions to a user in response to a consultation request or identified need.

The term “recommendation target information” refers to generated information that specifies one or more items, services, or options recommended to a user, including associated descriptions and reasons for recommendation.

The term “prompt sentence” refers to a textual instruction or query provided as input to a generative artificial intelligence model, specifying a desired task, context, or output format to guide the model's generation process.

The term “generative artificial intelligence model” refers to a computational model trained on data to generate new information, such as text or other content, in response to input including a prompt sentence, by predicting or constructing outputs according to learned patterns.

The term “information technology” refers to techniques, systems, and services that use computers, networks, or electronic devices to process, store, or communicate digital information.

The term “information processing” refers to operations in which digital data are received, transformed, analyzed, generated, or otherwise manipulated by a computing system.

The term “usability of an information technology or information processing” refers to a condition indicating whether a particular use of information technology or information processing is allowed or appropriate, taking into account policy constraints, safety requirements, or technical feasibility. The term “document data” refers to electronic representations of documents, including image data or file data that contain characters, symbols, or structured content, such as manuals, instruction sheets, or configuration guides.

The term “optical character recognition technique” refers to a processing technique that detects and converts character patterns contained in image data of a document into machine-readable text data. The term “setting information” refers to information specifying one or more parameters, options, or procedures required to configure or activate a system, device, or service.

The term “structured data” refers to data arranged according to a predefined format or schema, such as key-value pairs, tables, or hierarchical objects, enabling systematic access and processing. The term “explanatory information” refers to generated information that describes, explains, or instructs how to perform a task, including textual instructions or stepwise guidance for a user. The term “stepwise guiding” refers to a mode of presenting instructions in which a sequence of discrete steps is provided to a user in an ordered manner so that the user can progress through a task sequentially.

The term “setting operation” refers to a series of user interactions or system actions that apply configuration parameters or options to a system, device, or service to place it into a desired operational state.

The term “service start procedure” refers to a sequence of operations required to activate, initialize, or begin use of a service, including registration, authentication, configuration, and confirmation steps.

The term “facial information” refers to data representing one or more attributes of a user's face, including images, extracted feature points, or other characteristics obtained from a sensor such as a camera.

The term “voice information” refers to data representing a user's spoken sounds, including audio waveforms, extracted acoustic features, or recognized speech content obtained from a sensor such as a microphone.

The term “emotional state” refers to an estimated internal state of a user, such as being stressed, confused, relaxed, or focused, inferred from observed signals including facial information, voice information, or behavioral patterns.

The term “degree of detail of the explanatory information” refers to a level indicating how fine-grained, extensive, or elaborated the content of explanatory information is, including the number of steps, amount of text, and inclusion of explanations.

The term “expression style of the explanatory information” refers to a manner of presenting explanatory information, including linguistic tone, formality, technicality, and phrasing patterns used in the instructions.

The term “correct the explanatory information” refers to modifying, rewriting, or adjusting previously generated explanatory information in accordance with additional conditions, such as an emotional state of a user.

The term “user terminal” refers to an information processing apparatus operated by a user, such as a mobile device, a personal computer, or another client device, configured to communicate with the server and present information to the user.

The term “operation history information” refers to data representing records of actions performed by a user on a user terminal, such as selections, inputs, transitions between screens, and durations of operations.

The term “usage information regarding the corrected explanatory information” refers to data indicating how a user interacts with and utilizes the corrected explanatory information, including which steps are followed, where the user hesitates, or when the user exits.

The term “evaluation criterion information” refers to information specifying one or more conditions, rules, or thresholds used to evaluate the quality, safety, or appropriateness of generated consultation content or recommendation target information.

The term “quality evaluation result” refers to an outcome of an evaluation process indicating whether generated information satisfies one or more evaluation criteria, including classifications, scores, or flags.

The term “rule-based determination process” refers to a decision-making process in which predetermined logical rules, conditions, or patterns are applied to input data to derive a determination or classification.

The term “filter the consultation content or the recommendation target information” refers to selecting, removing, or modifying part or all of the consultation content or recommendation target information according to a quality evaluation result or other criteria.

In one embodiment, a server, a terminal, and a user cooperate to implement the claimed system. The server includes at least one processor, a main memory, a nonvolatile storage device, and a network interface. The terminal includes at least one processor, a display, a camera, a microphone, a local storage device, and a wireless or wired communication interface. The user operates the terminal and provides implicit and explicit inputs to the system.

The server executes an operating system, for example a general-purpose server operating system, and executes application software implemented in a programming language such as a high-level language. The server accesses one or more data storage systems, for example a relational database management system, to persist past information. The server further executes numerical computation libraries and data processing libraries, such as matrix computation libraries and table-processing libraries, to perform statistical analysis of past information. The server still further communicates with a generative AI model that is deployed either on the server itself or on an external computing platform.

The server stores past information in a structured form. The server represents consultation history information and operation history information as records in database tables, each record including fields such as user identifier, timestamp, category label, textual content, and outcome label. The server represents viewing histories and recommendation usage histories similarly. The server loads such records into memory as table-like data structures, for example two-dimensional arrays or keyed collections, and performs statistical analysis over those structures. The server computes counts, frequencies, moving averages, and probability distributions over user actions and categories. The server thereby generates tendency information of a user, in the form of parameter vectors or profile objects that indicate preferences, typical response patterns, and frequently selected options. The server uses the tendency information and consultation history information to construct one or more prompt sentences for a generative AI model. The server represents each prompt sentence as a character string in a text encoding and concatenates several sections: a task description section, a context section that includes the user's tendency information serialized as text, and an instruction section specifying output format or constraints. For example, the server may generate a prompt sentence such as:

“Based on the following user tendency profile and past consultation records, generate consultation content that proposes concrete actions for the user. Use short paragraphs and list format where appropriate.
User tendency profile: [Action preference: high, Technical skill: low, Anxiety: medium] Past consultations: [1) . . . 2) . . . ]”
or
“Based on the following viewing history profile, generate a list of 10 recommended action movies for this user, including a short explanation for each recommendation.”

The server then sends the prompt sentence to a generative AI model. In one embodiment, the generative AI model is a transformer-based neural network. The server accesses the generative AI model via an application programming interface over a network. The generative AI model internally includes multiple layers of self-attention blocks, feed-forward blocks, normalization layers, and embedding tables. The generative AI model is pre-trained on large-scale text corpora using an unsupervised objective such as next-token prediction. The generative AI model is fine-tuned on domain-specific data including consultation transcripts and guidance texts.

The generative AI model receives the prompt sentence as tokenized input, where the server or the model's front-end converts the character string into a sequence of numerical token identifiers. The generative AI model maps these token identifiers to high-dimensional vectors using an embedding table, processes the vectors through the attention and feed-forward layers using matrix multiplications and nonlinear activation functions, and outputs probability distributions over possible next tokens at each step. The generative AI model samples or selects tokens with high probabilities under specified parameters, such as temperature and top-k thresholds, and returns the generated token sequence. The server decodes the token sequence back into a character string, which constitutes consultation content or recommendation target information.

The server generates additional prompt sentences for determining usability of an information technology or information processing based on the generated consultation content or recommendation target information. The server builds a prompt sentence that includes policy rules or evaluation criteria, together with the generated content. For example, the server may generate a prompt sentence such as:
“Given the following consultation response and the following policy rules, determine whether the proposed use of information technology is allowed. Return ‘ALLOW’ or ‘DENY’ and briefly explain the reason.
Consultation response: [ . . . ]
Policy rules: [ . . . ]”

The server inputs this prompt sentence to the same or a different generative AI model. Internally, the generative AI model processes the input tokens and outputs a structured or semi-structured textual judgment. The server parses the output to determine whether the use of information technology is allowable. The server further implements a rule-based determination module that checks explicit conditions such as age restrictions, prohibited categories, and mandatory warnings. The server combines the generative AI-based judgment with the rule-based judgment to produce a final usability decision. This combination reduces false positives and false negatives compared with using only rules or only model output.

The server extracts setting information from document data when the use of information technology or information processing is determined to be allowable. The terminal captures document data using its camera or accesses digital manuals stored in files. The terminal transmits images or file data to the server via the network interface. The server executes an optical character recognition engine to detect character shapes and convert them into machine-readable text. The optical character recognition engine applies image preprocessing operations, such as binarization, skew correction, and noise reduction, and then detects character regions and performs recognition using trained classification models. The server obtains character strings corresponding to headings, labels, and values.

The server then parses the recognized text to extract setting information. The server applies pattern matching over the character strings using regular expressions and dictionary-based keyword matching. The server searches for patterns corresponding to configuration parameters, such as network identifiers, activation codes, server addresses, and menu item names. The server associates parameter labels and values in structured data, for example in key-value maps or hierarchical records. The server thereby generates structured data that contain setting information in a form directly usable by later processing.

The server uses the structured data to generate explanatory information for stepwise guiding a user. The server constructs a further prompt sentence that includes the structured data and a specification of the user's level and desired style. For example, the server may generate a prompt sentence such as:
“Using the following setup information, generate step-by-step instructions for a beginner user to start using the service. Use numbered steps, simple language, and avoid technical jargon.
Setup information: [Network name: . . . , Activation code: . . . , Configuration menu path: . . . ]”
or
“Rewrite the following setup instructions so that an experienced user can complete the configuration quickly. Use concise sentences and group operations where possible.”

The server inputs this prompt sentence to the generative AI model. The model processes the prompt as before, and outputs a sequence of tokens that form explanatory information. The explanatory information includes sequential instructions, actions to perform on menus, values to input, and expected confirmations. The server parses the explanatory information into structured guidance objects, associating each step with identifiers, display text, and potential branching conditions. The terminal receives the explanatory information and recommendation target information from the server. The terminal stores the information in local memory and renders the information on the display. The terminal implements a user interface that displays recommended items with explanations and that provides a wizard-style interface for the explanatory information. The terminal associates each step in the explanatory information with interface elements such as buttons, progress indicators, and optional help panels. The terminal interacts with input devices such as touch sensors and keyboards, and updates the visual state accordingly.

The terminal acquires facial information and voice information of the user. The terminal uses its camera to capture images or video streams of the user's face, and uses its microphone to capture audio signals. The terminal executes computer vision algorithms to detect facial regions and extract facial landmarks. The terminal uses convolutional neural networks or similar classifiers to predict emotion labels based on features derived from the facial landmarks, such as relative positions of eyes, eyebrows, and mouth. The terminal also executes signal processing algorithms to compute acoustic features from the audio signal, such as pitch contours, energy distributions, and speech rate. The terminal uses a classifier, for example a neural network or a support vector machine, to infer emotional state from these acoustic features.

The terminal sends the estimated emotional state to the server, or the server requests and receives this state periodically. The server stores the emotional state together with time stamps and context identifiers. The server then modifies explanatory information in response to the emotional state. The server generates another prompt sentence that requests modification of explanatory information to match the detected emotional state. For example, the server may generate a prompt sentence such as:
“The user is confused and stressed. Rewrite the following instructions with more detailed steps, add reassurance phrases, and avoid technical terms.”
or
“The user is calm and experienced. Compress the following instructions into a minimal checklist with only essential steps.”

The server inputs the prompt sentence and the current explanatory information to the generative AI model. The model generates corrected explanatory information that changes the degree of detail and expression style according to the emotional state. The server replaces or augments existing guidance with the corrected explanatory information and transmits the updated version to the terminal. The terminal updates the displayed guidance dynamically without restarting the interaction.

The server continuously receives operation history information and usage information regarding the explanatory information from the terminal. The terminal records user actions such as step transitions, time spent per step, error messages triggered, and cancellations. The terminal sends such logs to the server. The server stores the logs as part of past information and updates user tendency information and prompt construction logic. The server applies statistical analysis to determine, for example, which steps frequently cause hesitation, which explanations result in fewer failures, and which guidance patterns correlate with successful task completion. The server adjusts parameters in prompt templates, such as desired length, level of technical detail, and structure of lists, and in thresholds for usability and quality evaluation. This feedback loop allows the system to improve computational efficiency and accuracy over time without manual rewriting of all prompts.

In one embodiment, the generative AI model is implemented as a transformer with multiple attention heads per layer and feed-forward layers with activation functions. The model is trained using backpropagation on a large corpus of training data. The training process minimizes a loss function, such as cross-entropy loss, between predicted token distributions and actual tokens in the training sequences. The model parameters (weight matrices and bias vectors) are updated using an optimization algorithm, such as stochastic gradient descent or an adaptive gradient method. Data augmentation techniques can be used during fine-tuning, for example shuffling of sections, paraphrasing, and masking of tokens, to improve robustness. The server may store different versions of the model or different prompts optimized for different domains.

The server uses specific data structures and control logic to reduce computation and communication overhead. The server stores user tendency information as compact vectors or low-dimensional embeddings that summarize preferences. The server generates prompt sentences by assembling template segments and variable segments, which reduces string processing overhead. The server batches multiple prompt requests and sends them to the generative AI model in a single call, thereby reducing network round trips. The server also caches model outputs for repeated or similar inputs, reducing repeated computation. These techniques improve processing speed and reduce load on both the server and the generative AI platform.

By integrating usability judgment and quality evaluation into the generative workflow using prompt sentences and internal rule-based modules, the server reduces the number of times it must perform separate natural language parses and policy checks. The server avoids multiple serialization and re-parsing of generated content, thereby reducing memory copying and intermediate object creation. The server thus improves throughput and responsiveness when serving many terminals concurrently.

The system achieves technical effects that go beyond merely automating human mental processes. The server and terminal jointly implement specific algorithms and data flows that optimize the use of computational resources. The statistical generation of user tendency information guides prompt construction so that the generative AI model operates on well-contextualized inputs, which stabilizes output quality and reduces the need for repeated calls. The tightly coupled handling of optical character recognition, structured data extraction, and generative guidance reduces redundant text manipulation and enables direct conversion from physical documents to machine-executable guidance structures. The emotion-aware correction mechanism provides adaptive content that matches a user's state in real time without requiring the user to manually select guidance styles, thereby reducing interaction steps and server round trips.

In another embodiment, the generative AI model is deployed on-premise within the server, and the server's processor performs both model execution and other logic. Static weights are stored in nonvolatile memory, and the server uses hardware acceleration, such as vector instruction sets or dedicated accelerators, to execute matrix operations. In a further embodiment, the server uses a smaller, distilled model for low-latency tasks and a larger model for tasks that tolerate higher latency. The server selects between models based on context and resource availability. These variations provide trade-offs between latency, resource usage, and accuracy.

In yet another embodiment, the terminal performs part of the generative processing. The terminal may host a smaller generative model optimized for on-device execution, and the server may supply updated prompt templates and tendency information. The terminal can then generate or adjust certain guidance locally, reducing network usage and improving responsiveness when network conditions are poor.

Through these embodiments, the server, the terminal, and the user cooperate to realize a system in which past information, prompt sentences, generative AI models, optical character recognition, rule-based checks, and emotion estimation are integrated into a coherent technical architecture. This architecture improves computing performance, guidance accuracy, and adaptability, and thereby supports the scope of the claimed invention.

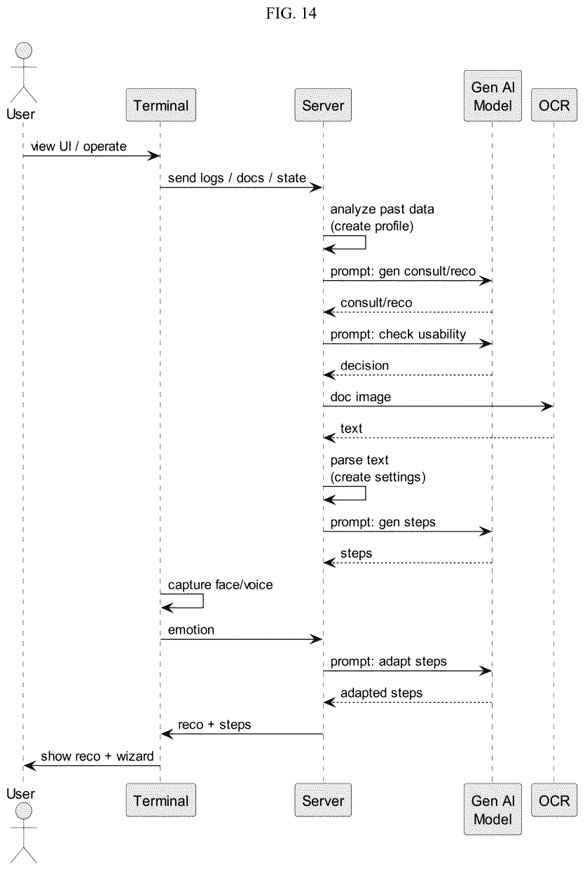

The following describes the processing flow using FIG. 14.

### Step 1:

Server collects past information and generates user tendency information.

Server receives past information as input data from one or more storage units, such as a database storing viewing logs, consultation logs, and operation history logs. Server executes queries to obtain records including user identifiers, timestamps, categories, and textual content. Server loads the records into an in-memory table structure and performs statistical analysis, such as counting occurrences of categories, computing frequencies of actions, and calculating averages of task completion times. Based on these computations, server generates user tendency information as an output, for example a vector or profile object indicating user preferences, typical behavior patterns, and inferred skill level.

### Step 2:

Server constructs a prompt sentence to generate consultation content or recommendation target information.

Server takes the user tendency information and consultation history information as input. Server serializes the tendency information and a subset of relevant consultation records into textual form. Server concatenates a task description, the serialized tendency information, and the consultation history into a single character string. This character string is the prompt sentence. For example, server generates a prompt sentence such as: “Based on the following user tendency profile and past consultation records, generate consultation content that proposes concrete actions for the user.” Server outputs this prompt sentence as text ready to be sent to a generative AI model.

### Step 3:

Server generates consultation content or recommendation target information using a generative AI model.

Server uses the prompt sentence from Step 2 as input to a generative AI model. Server tokenizes the prompt sentence into numerical token identifiers and transmits them to the generative AI model via an interface. Internally, the generative AI model performs matrix multiplications, attention computations, and nonlinear transformations to compute probability distributions over next tokens. Server receives the output token sequence from the generative AI model, decodes it into a text string, and parses the string into structured data. The output is consultation content or recommendation target information, including recommended items or suggested actions, represented as a list of entries or a structured text block.

### Step 4:

Server judges usability of information technology or information processing based on generated content.

Server takes the generated consultation content or recommendation target information as input. Server also retrieves evaluation criterion information such as policy rules or safety constraints. Server constructs a second prompt sentence that embeds both the generated content and the evaluation criteria, for example: “Given the following consultation response and the following policy rules, determine whether the proposed use of information technology is allowed.” Server tokenizes this second prompt sentence and inputs it to the generative AI model. Server receives a textual judgment, parses it to determine an “allow” or “deny” result, and optionally combines this result with rule-based checks implemented in code. The output is a usability decision and, when allowed, a filtered version of the consultation content or recommendation target information.

### Step 5:

Server extracts setting information from document data using an optical character recognition technique.

Server uses document data as input, where the document data comprise image files or electronic manuals received from the terminal. Server invokes an optical character recognition engine, which performs image preprocessing, segmentation, and character classification to convert visual patterns into text. Server receives raw recognized text and applies pattern matching and keyword detection to identify configuration labels and values. Server constructs structured data, such as key-value pairs representing network identifiers, activation codes, and configuration menu paths. The output is structured setting information derived from the original document data.

### Step 6:

Server constructs a prompt sentence to generate explanatory information for stepwise guidance. Server uses the structured setting information as input. Server converts the structure into a textual description that includes labels and values. Server then assembles a prompt sentence that specifies the desired guidance format, for example: “Using the following setup information, generate step-by-step instructions for a beginner user to start using the service.” Server includes the serialized setting information at the end of the prompt. Server outputs this prompt sentence as a text string, prepared for submission to the generative AI model.

### Step 7:

Server generates explanatory information using the generative AI model.

Server provides the prompt sentence from Step 6 as input to the generative AI model. Server tokenizes the prompt and sends the tokens to the model. The generative AI model performs its internal computations to predict a coherent sequence of tokens representing instructions. Server receives the token sequence as output, decodes it into a text string, and parses it into a sequence of steps, each step containing a directive and any associated parameters. The output is explanatory information formatted as stepwise guidance that instructs the user how to perform a setting operation or service start procedure.

### Step 8:

Terminal acquires facial information and voice information of the user and estimates an emotional state.

Terminal uses its camera and microphone to capture visual and audio signals as input. Terminal runs face detection algorithms to locate the user's face in captured frames and extracts facial landmarks. Terminal computes feature vectors from these landmarks and from acoustic features of the audio signal, such as pitch and intensity. Terminal feeds the feature vectors to an emotion classification model implemented locally or via a remote service. The emotion classification model applies learned parameters to map the features to one of several emotional states. The output is an estimated emotional state of the user, along with a confidence score.

### Step 9:

Server corrects explanatory information based on the emotional state.

Server receives the emotional state of the user as input from the terminal, together with the current explanatory information. Server determines whether to increase or decrease the level of detail and whether to change the tone or structure of the guidance. Server constructs a prompt sentence that requests a specific modification, for example: “The user is confused and stressed. Rewrite the following instructions with more detailed steps and simpler language.” Server appends the current explanatory information to the prompt and sends it to the generative AI model. The model generates modified guidance text, which server decodes and converts into an updated sequence of steps. The output is corrected explanatory information whose degree of detail and expression style are adjusted to the emotional state.

### Step 10:

Server transmits selected recommendation target information and corrected explanatory information to the terminal.

Server uses the filtered consultation content or recommendation target information and the corrected explanatory information as input. Server packages these data into a response message, optionally encoding them as structured records. Server sends the response message via a communication interface to the terminal. The output is a network transmission that delivers both recommended items and adapted guidance steps to the terminal for presentation to the user.

### Step 11:

Terminal displays recommendation target information and explanatory information to the user.

Terminal receives the response message from the server as input. Terminal parses the received data to separate recommendation items from guidance steps. Terminal renders recommendation items on a list or grid view, showing titles and short explanations, and renders the guidance steps in a wizard interface that shows one or more steps at a time. Terminal updates the display in response to user interactions, such as scrolls and button presses. The output is a visual and interactive presentation that allows the user to select recommendations and follow the guidance.

### Step 12:

User interacts with recommendations and guidance, and terminal records operation history information.

User views the displayed recommendation target information and explanatory information as input stimuli. User taps on recommended items, follows or skips guidance steps, and enters configuration values when prompted. Terminal monitors these interactions and records operation history information, including which items were selected, how long the user remained on each step, and where the user encountered difficulties. Terminal structures this information as log entries and prepares it for transmission. The output is a set of operation history records reflecting actual user behavior.

### Step 13:

Terminal transmits past information including operation history and usage information to the server. Terminal uses the operation history information and usage information regarding the explanatory information as input. Terminal aggregates multiple log entries into a message and sends the message to the server via the communication interface. The message may include timestamps, step identifiers, and emotional states at specific times. The output is transmitted past information that supplements or updates the server's stored records.

### Step 14:

Server updates past information and refines user tendency information and prompt construction. Server receives the new past information from the terminal as input. Server appends the information to its databases and updates statistical aggregates. Server recalculates user tendency information by recomputing frequencies, averages, and other statistics over the enlarged dataset. Server also analyzes correlations between certain types of explanatory information and successful task completion or reduced error rates. Server adjusts templates and parameters used to construct prompt sentences, such as desired length, complexity, and emphasis on particular aspects. The output is updated user tendency information and revised prompt construction logic, which are used in subsequent executions of earlier steps.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

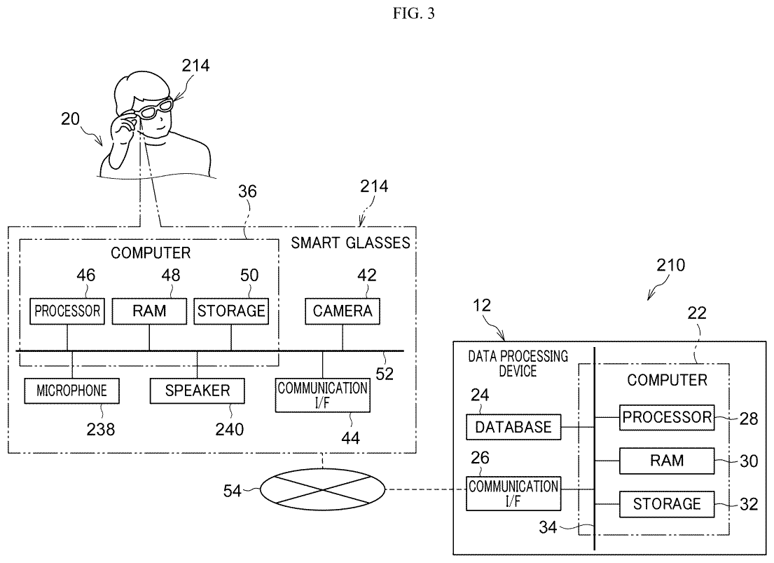

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

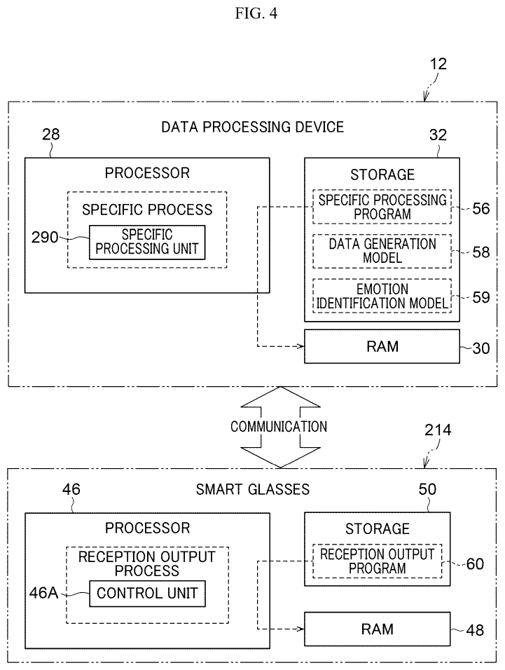

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

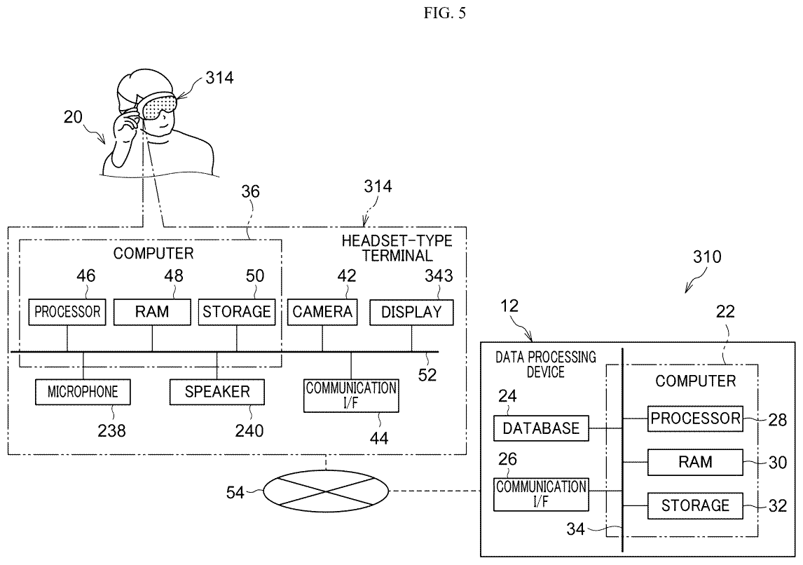

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

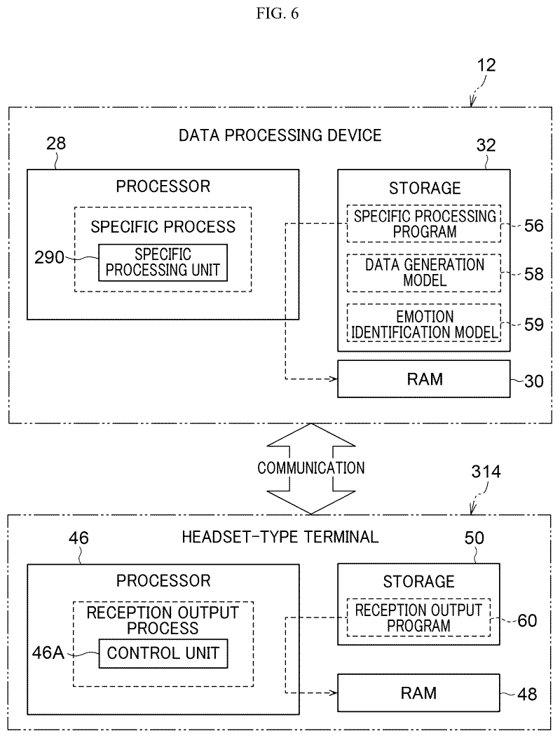

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

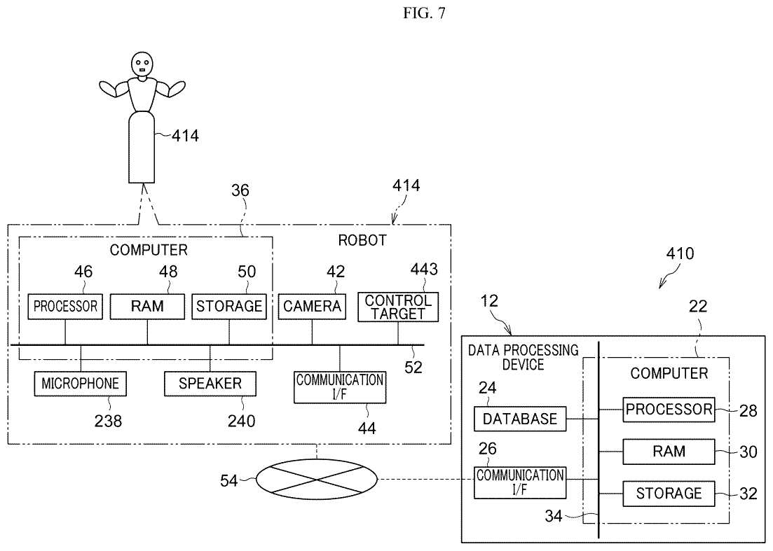

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

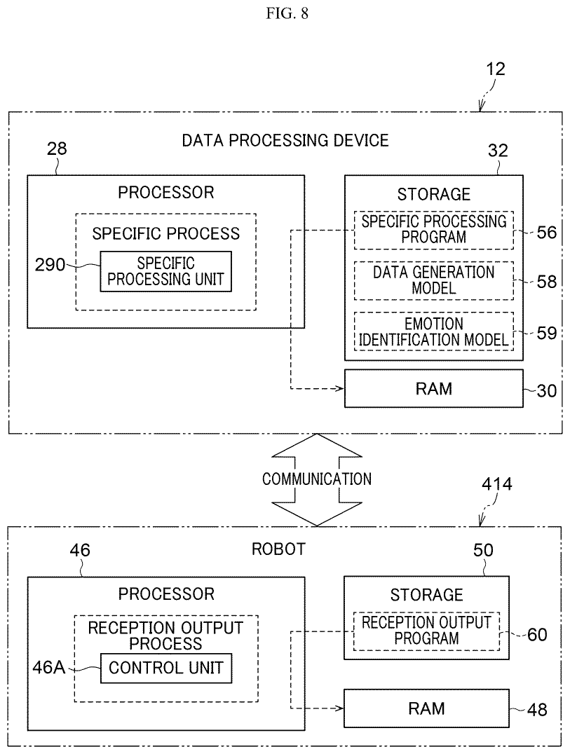

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

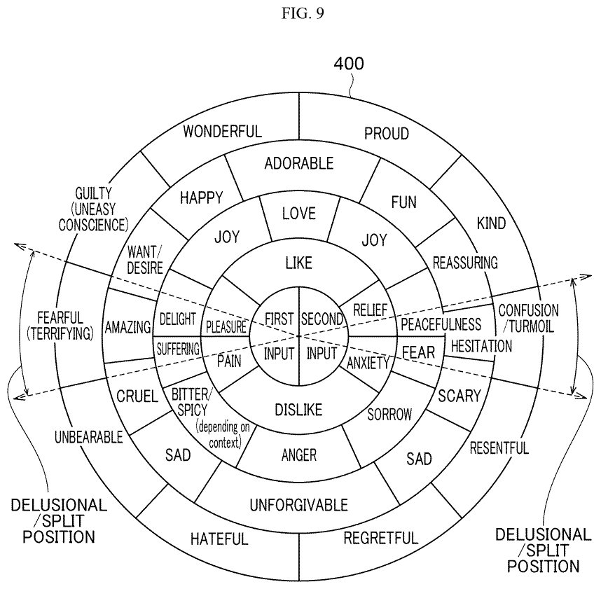

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

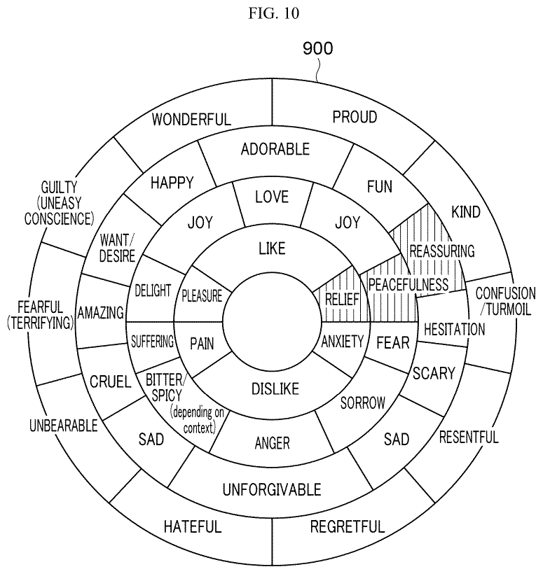

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire past information from an information storage unit storing the past information, provide the past information as input data to a generative AI model that performs natural language processing, and transmit input data including a prompt sentence that instructs the generative AI model to summarize the past information and to generate new consultation content, and obtain the generated consultation content from the generative AI model,
analyze the generated consultation content by performing language analysis processing and rule-based determination processing based on predetermined evaluation criteria to determine usability of information technology, generate input data including a prompt sentence that specifies evaluation items used in the evaluation criteria, transmit the input data to the generative AI model to assist the determination processing, and generate a determination result indicating whether the information technology is usable, and
in a case where the determination result indicates that the information technology is usable, activate a character recognition mechanism to perform character recognition processing on document image data by a computing device or a terminal device, extract character string data including setting information from the document image data, execute data extraction processing to extract configuration items including connection destination information and authentication information from the extracted setting information, generate a prompt sentence including instruction content that stepwise structures a start-of-use procedure based on the configuration items, input the prompt sentence to the generative AI model to cause the generative AI model to generate a guidance text describing the start-of-use procedure in natural language, and present the guidance text to a user.

### Supplementary 2

The system according to supplementary 1,
wherein the processor is configured to
apply a pattern recognition algorithm based on the past information and the generated consultation content, by generating a prompt sentence that specifies processing conditions and an output format for classification of consultation content, extraction of technical fields, extraction of risk factors, and evaluation of complexity, and by inputting the prompt sentence to the generative AI model to cause the generative AI model to assist execution of the pattern recognition algorithm.

### Supplementary 3

The system according to supplementary 1,
wherein the processor is configured to
generate setting sequence information by determining, based on the setting information extracted by the character recognition processing, a priority, a dependency, and an input format of each setting item, and by assigning metadata indicating results of the determining to the setting items, generate a prompt sentence that specifies configuration content of an interactive procedure for providing a user with stepwise operation instructions, confirmation requests, and corrective guidance in an error case in accordance with the setting sequence information, and input the prompt sentence to the generative AI model to cause the generative AI model to generate a guidance text that expresses the interactive procedure in natural language.

### Application Example 1

### Supplementary 1

A system comprising a processor,
wherein the processor is configured to
receive past information as input data, generate a prompt sentence for a generative AI model to cause the generative AI model to analyze the input data and generate consultation content, and input the prompt sentence to the generative AI model,
refer to evaluation conditions based on the consultation content output from the generative AI model, determine whether use of an information processing resource is permitted, generate a prompt sentence for the generative AI model for determining the permissibility of the use of the information processing resource, and input the prompt sentence to the generative AI model,
when the use of the information processing resource is determined to be permitted, input a document acquired as image data to a character recognition algorithm, extract configuration information from the document, and convert the extracted configuration information into structured data,
integrate the configuration information expressed as the structured data with past work history data related to the consultation content, generate guidance content for performing stepwise guidance to a user, generate a prompt sentence for the generative AI model for generating the guidance content, and input the prompt sentence to the generative AI model,
receive the past work history data and the consultation content as inputs, generate a prompt sentence for the generative AI model for generating new work instruction information for an automated work apparatus, and input the prompt sentence to the generative AI model to acquire the work instruction information,
compare the work instruction information with safety conditions and operational conditions, determine appropriateness of the work instruction information, determine control parameters to be set in the automated work apparatus based on a result of the determination, transmit the control parameters to the automated work apparatus, and cause the automated work apparatus to start work, transmit guidance information including the guidance content and the work instruction information to a user information terminal via a communication network, and cause the user information terminal to provide guidance to the user through display or audio output, and
store execution result information acquired from the automated work apparatus and feedback information acquired from the user as history information, and update the history information into a format usable as input data for the generative AI model for subsequent generation of the consultation content and subsequent generation of the work instruction information.

### Supplementary 2

The system according to supplementary 1,
wherein the processor is configured to generate a prompt sentence for the generative AI model for instructing application of a pattern recognition algorithm based on the past information and the execution result information, and input the prompt sentence to the generative AI model in generation of the consultation content and generation of the work instruction information.

### Supplementary 3

The system according to supplementary 1,
wherein the processor is configured to generate a prompt sentence for the generative AI model for generating interactive guidance content that requests, in a stepwise manner, confirmation operations and correction inputs from the user, based on the extracted configuration information, the work instruction information, and the evaluation conditions, and input the prompt sentence to the generative AI model.

### Example 2

### Supplementary 1

A system comprising a processor, and a memory storing instructions which, when executed by the processor, cause the processor to:
acquire past information stored in a storage device, and generate a prompt sentence to be input to a generative AI model, the prompt sentence including the past information as input data and being transmitted to the generative AI model so that consultation content is generated;
apply, to consultation content output from the generative AI model, an evaluation algorithm based on reference information to determine usability of the consultation content, and control recording of the consultation content in the storage device or control re-generation of the consultation content in accordance with a result of the determination;
obtain document data associated with consultation content determined to be usable in the determination of usability, extract character information from the document data by using an optical character recognition technique, and perform analysis based on pattern matching or natural language processing on the character information to extract configuration information relating to system settings;
format the extracted configuration information as structured data, generate, based on the structured data, a prompt sentence including guide information for providing stepwise setting operations to a user terminal, input the prompt sentence to the generative AI model so that user guidance text is generated, and transmit the user guidance text and the configuration information to the user terminal; and
receive setting values transmitted from the user terminal, verify the setting values by comparing the setting values with the configuration information, and update system configuration information based on a result of the verification to set a usage-start state of a system.

### Supplementary 2

The system according to supplementary 1,
wherein the processor is configured to generate the prompt sentence to be input to the generative AI model such that the prompt sentence includes condition information for instructing execution of pattern recognition processing based on the past information, and to control adjustment of a structure of the consultation content or evaluation criteria for the consultation content based on feature information extracted by the pattern recognition processing.

### Supplementary 3

The system according to supplementary 1,
wherein the processor is configured to classify the extracted configuration information into a plurality of configuration item groups including at least a network setting group, an authentication setting group, a user privilege setting group, and an error handling setting group, define, for each of the configuration item groups, step information including input items, recommended values, and confirmation procedures, generate navigation information for stepwise control of screen transitions and input interfaces to be displayed on the user terminal based on the step information, and input a prompt sentence reflecting contents of the navigation information to the generative AI model.

### Application Example 2

### Supplementary 1

A system comprising a processor,
wherein the processor is configured to
receive past information as input data and perform statistical analysis on the input data to generate tendency information of a user,
generate a prompt sentence for generating consultation content or recommendation target information based on the tendency information of the user and consultation history information included in the past information, and input the prompt sentence to a generative AI model to generate the consultation content or the recommendation target information,
generate a prompt sentence for determining usability of an information technology or information processing based on the generated consultation content or the recommendation target information, input the prompt sentence to the generative AI model to determine the usability, and select the consultation content or the recommendation target information according to a result of the determination of the usability,
extract setting information from document data by using an optical character recognition technique when use of the information technology or the information processing is determined to be allowable, and generate structured data including the extracted setting information,
generate a prompt sentence for generating explanatory information for stepwise guiding a user to perform a setting operation or a service start procedure based on the structured data, and input the prompt sentence to the generative AI model to generate the explanatory information,
analyze facial information or voice information of the user to estimate an emotional state of the user, generate a prompt sentence for changing a degree of detail or an expression style of the explanatory information according to the emotional state, and input the prompt sentence to the generative AI model to correct the explanatory information, and
transmit the corrected explanatory information and the selected recommendation target information to a user terminal for display at the user terminal.

### Supplementary 2

The system according to supplementary 1,
wherein the processor is configured to
receive operation history information of the user and usage information regarding the corrected explanatory information from the user terminal as part of the past information, and update the tendency information of the user and the prompt sentences based on the operation history information and the usage information.

### Supplementary 3

The system according to supplementary 1,
wherein the processor is configured to
generate a prompt sentence for performing quality evaluation based on the generated consultation content or the recommendation target information and predetermined evaluation criterion information, input the prompt sentence to the generative AI model to obtain a quality evaluation result by using at least one of the generative AI model and a rule-based determination process, and filter the consultation content or the recommendation target information based on the quality evaluation result.

What is claimed is:

1. A system comprising:
circuitry configured to:
acquire, via a communication interface coupled to a packet-switched network, past information stored in a storage device, and provide the past information as input data to a generative neural network model together with a first prompt sentence that instructs the generative neural network model to analyze the input data and generate consultation content;
perform language analysis processing and rule-based determination processing on the generated consultation content based on predetermined evaluation criteria, generate a second prompt sentence that specifies evaluation items used in the predetermined evaluation criteria, and provide the second prompt sentence to the generative neural network model to generate a determination result indicating whether use of an information technology configuration is permitted;
in response to the determination result indicating that the information technology configuration is permitted, control a character recognition mechanism to perform character recognition processing on document image data to extract character string data including setting information, and execute data extraction processing on the character string data to obtain configuration items including connection destination information and authentication information;
generate setting sequence information by determining a priority and a dependency of each configuration item, generate a third prompt sentence that specifies a stepwise procedure based on the setting sequence information and the configuration items, and provide the third prompt sentence to the generative neural network model to generate guidance text describing the stepwise procedure; and
transmit, via the communication interface, the guidance text as a notification data packet to a terminal device for presentation to a user.

2. The system according to claim 1, wherein the past information comprises historical consultation records, each record including fields for consultation text, a domain label, a timestamp, and a configuration outcome, and wherein the circuitry is configured to filter the historical consultation records according to at least one of a domain label condition or a date range condition prior to providing the past information as the input data.

3. The system according to claim 2, wherein the circuitry is configured to compute, for each historical consultation record, a vectorized representation using an embedding layer of the generative neural network model, and to select a subset of the historical consultation records based on a similarity measure between the vectorized representation and a current configuration context vector.

4. The system according to claim 3, wherein the generative neural network model comprises a transformer-based architecture including multiple self-attention layers, feed-forward layers, and layer normalization, and wherein the circuitry is configured to control a decoding parameter including at least one of a temperature parameter or a top-k sampling threshold during generation of the consultation content.

5. The system according to claim 1, wherein the rule-based determination processing comprises applying a rule set that specifies at least one of a required technical term condition, a risk pattern condition, or a complexity threshold condition to features extracted from the consultation content, and wherein the circuitry is configured to compute a weighted score from the rule set and compare the weighted score to a threshold to generate the determination result.

6. The system according to claim 5, wherein the circuitry is configured to generate, when the determination result indicates that the information technology configuration is not permitted, a modified prompt sentence that includes additional constraint information, and to provide the modified prompt sentence to the generative neural network model to re-generate the consultation content, thereby forming an iterative feedback loop.

7. The system according to claim 5, wherein the circuitry is configured to apply a pattern recognition algorithm to the generated consultation content by generating a prompt sentence that specifies processing conditions and an output format for at least one of classification of the consultation content, extraction of technical fields, extraction of risk factors, or evaluation of complexity.

8. The system according to claim 1, wherein the character recognition mechanism comprises an optical character recognition engine that applies image preprocessing including at least one of binarization, skew correction, or noise reduction to the document image data prior to performing the character recognition processing.

9. The system according to claim 8, wherein the data extraction processing comprises applying pattern matching using regular expressions to identify at least one of a network address pattern, a uniform resource locator pattern, a port number pattern, or an authentication credential pattern in the character string data, and associating identified patterns with labels to form the configuration items as key-value pairs.

10. The system according to claim 9, wherein the circuitry is configured to classify the configuration items into a plurality of configuration item groups including at least a network setting group, an authentication setting group, a user privilege setting group, and an error handling setting group, and to define step information for each configuration item group including input items, recommended values, and confirmation procedures.

11. The system according to claim 1, wherein the circuitry is configured to model the configuration items as nodes in a directed acyclic graph with edges representing dependency relations between the configuration items, and to perform a topological sort on the directed acyclic graph to determine an execution order for the setting sequence information.

12. The system according to claim 11, wherein the circuitry is configured to attach metadata to each configuration item in the setting sequence information, the metadata including an input format specification, an allowed value range, and a validation pattern.

13. The system according to claim 1, wherein the circuitry is configured to receive, from the terminal device, setting values entered by the user in response to the guidance text, compare the setting values with the configuration items to verify consistency, and update system configuration information based on a result of the verification to set a usage-start state.

14. The system according to claim 13, wherein the circuitry is configured to perform an active connectivity check by transmitting a test data packet to a network address specified in the setting values and determining whether a response is received within a threshold time period.

15. The system according to claim 1, wherein the circuitry is configured to store execution result information and feedback information received from the terminal device as history information in the storage device, and to update the history information into a format usable as input data for the generative neural network model for subsequent generation of the consultation content.

16. The system according to claim 15, wherein the circuitry is configured to analyze the history information to identify at least one of a recurring error pattern, a frequently corrected configuration item, or a suboptimal determination, and to adjust at least one of a rule threshold in the predetermined evaluation criteria or a prompt template used for generating the first prompt sentence based on the analysis.

17. The system according to claim 1, wherein the circuitry is configured to estimate an emotional state of the user based on at least one of facial image data captured by an image sensor of the terminal device or voice waveform data captured by a microphone of the terminal device, and to generate a correction prompt sentence that instructs the generative neural network model to adjust at least one of a degree of detail or an expression style of the guidance text according to the estimated emotional state.

18. A system comprising:
circuitry configured to:
acquire, via a communication interface coupled to a packet-switched network, past information including historical consultation records and past work history data from a storage device, and provide the past information as input data to a generative neural network model comprising a transformer-based architecture together with a first prompt sentence that instructs the generative neural network model to summarize the past information and generate consultation content;
perform language analysis processing including tokenization and named entity detection on the generated consultation content, apply rule-based determination processing based on predetermined evaluation criteria including required term conditions and complexity threshold conditions, and generate a determination result indicating whether use of an information technology configuration is permitted;
in response to the determination result indicating that the information technology configuration is permitted, control an optical character recognition engine to perform image preprocessing including binarization and skew correction on document image data and to extract character string data, and execute data extraction processing including regular expression pattern matching to obtain configuration items including connection destination information and authentication information from the character string data;
model the configuration items as nodes in a directed acyclic graph with edges representing dependency relations, perform a topological sort on the directed acyclic graph to derive setting sequence information, generate a prompt sentence that specifies a stepwise procedure based on the setting sequence information, and provide the prompt sentence to the generative neural network model to generate guidance text; and
transmit, via the communication interface, the guidance text as a notification data packet to a terminal device, receive setting values from the terminal device, and verify the setting values by comparing the setting values with the configuration items.

19. The system according to claim 18, wherein the circuitry is configured to integrate the configuration items expressed as structured data with the past work history data, generate work instruction information for an automated work apparatus by providing the past work history data and the consultation content to the generative neural network model, compare the work instruction information with safety conditions and operational conditions, and transmit control parameters derived from the work instruction information to the automated work apparatus via the communication interface.

20. A method comprising:
acquiring, via a communication interface coupled to a packet-switched network, past information stored in a storage device, and providing the past information as input data to a generative neural network model together with a first prompt sentence that instructs the generative neural network model to analyze the input data and generate consultation content;
performing language analysis processing and rule-based determination processing on the generated consultation content based on predetermined evaluation criteria, generating a second prompt sentence that specifies evaluation items used in the predetermined evaluation criteria, and providing the second prompt sentence to the generative neural network model to generate a determination result indicating whether use of an information technology configuration is permitted;
in response to the determination result indicating that the information technology configuration is permitted, controlling a character recognition mechanism to perform character recognition processing on document image data to extract character string data including setting information, and executing data extraction processing on the character string data to obtain configuration items including connection destination information and authentication information;
generating setting sequence information by determining a priority and a dependency of each configuration item, generating a third prompt sentence that specifies a stepwise procedure based on the setting sequence information and the configuration items, and providing the third prompt sentence to the generative neural network model to generate guidance text describing the stepwise procedure; and
transmitting, via the communication interface, the guidance text as a notification data packet to a terminal device for presentation to a user.
